SEQUENCE LISTING (2 sequences)

SEQ ID NO: 1 - DNA, 36 bp, ARTIFICIAL SEQUENCE
  SYNTHETIC OLIGONUCLEOTIDE
gggaagcttaggatggcgctccgagtcaccaggaac

SEQ ID NO: 2 - DNA, 30 bp, ARTIFICIAL SEQUENCE
  SYNTHETIC OLIGONUCLEOTIDE
gccggatcccacatattcactacaaaggtt

(19) United States
(12) Patent Application Publication
(10) Pub. No.: US 2006/0247862 A1
(43) Pub. Date: Nov. 2, 2006

(54) Determining cell cycle phase data

(76) Inventors: Nicholas S. Arini, South Glamorgan (GB); Ian D. Goodyer, South Glamorgan (GB); Alla B. Zaltsman, South Glamorgan (GB)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/550,362

(22) PCT Filed: Sep. 8, 2003
(86) PCT No.: PCT/GB03/03876

§ 371 Date: Jun. 21, 2006

(51) Int. Cl. G06F 19/00; G06K 9/00

(52) U.S. Cl. 702/19; 382/128

(57) ABSTRACT

A method of determining cell cycle phase data for cells comprising at least one luminescent reporter capable of emitting radiation, the at least one luminescent reporter comprising a first luminescent reporter which is capable of being indicative of at least one cell cycle phase, said method comprising: storing classification information for classifying individual cells into different cell cycle phases using an automated classification process; receiving image data created by detecting radiation emitted by said at least one luminescent reporter; analyzing said image data to identify object areas in the image data which correspond to individual cells; analyzing said image data, on the basis of said identified object areas, to determine, for a selected cell, one or more measurements including a measurement of a parameter relating to at least a cytoplasmic component of the cell; and applying said classification information to said measurements to classify the selected cell into a selected one of a plurality of sub-populations of cells, each sub-population having cells in a different cell cycle phase.

### FIELD OF THE INVENTION

The present invention relates to methods of determining cell cycle phase data for cells, the cells comprising a luminescent reporter which is capable of being indicative of at least one cell cycle phase. The invention further relates to apparatus and computer software adapted to carry out such a method.

### BACKGROUND OF THE INVENTION

There is currently a need in drug discovery and development and in general biological research for methods and apparatus for accurately performing cell-based assays. Cell-based assays are advantageously employed for assessing the biological activity of chemical compounds.

In addition, there is a need to quickly and inexpensively screen large numbers of chemical compounds. This need has arisen in the pharmaceutical industry where it is common to test chemical compounds for activity against a variety of biochemical targets, for example, receptors, enzymes and nucleic acids. These chemical compounds are collected in large libraries, sometimes exceeding one million distinct compounds. The use of the term chemical compound is intended to be interpreted broadly so as to include, but not be limited to, simple organic and inorganic molecules, proteins, peptides, nucleic acids and oligonucleotides, carbohydrates, lipids, or any chemical structure of biological interest.

In the field of compound screening, cell-based assays are run on populations of cells. The measured response is usually an average over the cell population. For example, a popular instrument used for ion channel assays is disclosed in U.S. Pat. No. 5,355,215. A typical assay consists of measuring the time-dependence of the fluorescence of an ion-sensitive dye, the fluorescence being a measure of the intra-cellular concentration of the ion of interest which changes as a consequence of the addition of a chemical compound. The dye is loaded into the population of cells disposed on the bottom of the well of a multiwell plate at a time prior to the measurement. In general, the response of the cells is heterogeneous in both magnitude and time. This variability may obscure or prevent the observation of biological activity important to compound screening. The heterogeneity may arise from experimental sources, but more importantly, heterogeneity is fundamental in any population of cells. Among others, the origin of the variability may be a consequence of the life-cycle divergence among the population, or the result of the evolutionary divergence of the number of active target molecules. A method that mitigates, compensates for, or even utilizes the variations would enhance the value of cell-based assays in the characterization of the pharmacological activity of chemical compounds.

Quantification of the response of individual cells circumvents the problems posed by the non-uniformity of that response of a population of cells. Consider the case where a minor fraction of the population responds to the stimulus. A device that measures the average response will have less sensitivity than one determining individual cellular response. The latter method generates a statistical characterization of the response profile permitting one to select the subset of active cells. Additional characterization of the population will enhance the interpretation of the response profile.

The cell cycle is of key importance to many areas of drug discovery. On the one hand this fundamental process provides the opportunity to discover new targets for anticancer agents and improved chemotherapeutics, but on the other hand drugs and targets in other therapeutic areas must be tested for undesirable effects on the cell cycle. Historically, a wide range of techniques have been developed to study the cell cycle both as a global biochemical process and at the molecular level.

Known methods include those that produce data describing the proliferative activity of a cell population.

Measuring the incorporation of [¹⁴C]— or [³H]-thymidine (Regan, J. D. and Chu, E. H. (1966) “A convenient method for assay of DNA synthesis in synchronized human cell cultures” J. Cell Biol. 28, 139-143) by scintillation counting was one of the earliest methods of determining cell proliferation, and is still widely used today. More recent developments (Graves, R. et al. (1997) “Noninvasive, real-time method for the examination of thymidine uptake events-application of the method to V-79 cell synchrony studies” Anal. Biochem. 248, 251-257) have allowed thymidine incorporation to be measured in a homogeneous microplate assay format.

Several non-radioactive alternatives to thymidine incorporation assays have been developed. These include enzyme-linked immunosorbent assay (ELISA) nucleotide bromo-deoxyuridine (BrdU) (Perros, P. and Weightman, D. R. (1991) “Measurement of cell proliferation by enzyme-linked immunosorbent assay (ELISA) using a monoclonal antibody to bromodeoxyuridine. Cell. Prolif. 24, 517-523; Wemme, H. et al. (1992) “Measurement of lymphocyte proliferation: critical analysis of radioactive and photometric methods” Immunobiology 185, 78-89) into replicating DNA, and staining of proliferation-specific antigens such as Ki-67 (Frahm, S. O. et al (1998) “Improved ELISA proliferation assay (EPA) for the detection of in vitro cell proliferation by a new Ki-67-antigen directed monoclonal antibody (Ki-S3)” J. Immunol. Methods 211, 43-50).

Colourimetric methods based on substrate conversion (Mosmann, T. (1983) “Rapid colourimetric assay for cellular growth and survival: application to proliferation and cytotoxicity assays” J. Immunol. Methods 65, 55-63; Roehm, N. W. et al. (1991) “An improved colourimetric assay for cell proliferation and viability utilizing the tetrazolium sal XTT” J. Immunol. Methods 142, 257-265) by mitochondrial and other cellular enzymes are also used to measure cell growth. Although these assays are often referred to as cell-proliferation assays, strictly speaking they are cell-mass assays. Unlike measuring thymidine or BrdU incorporation, these assays do not provide any inherent measure of cell cycle progression, and give only a measure of cell proliferation, that is, increase in cell number, relative to another population.

Other methods for measure cell proliferation (i.e. increasing cell numbers) have been reported based on measuring electrical impedance (Upadhyay, P. and Bhaskar, S. (2000) “Real time monitoring of lymphocyte proliferation by an impedance method” J. Immunol. Methods 244, 133-137), dissolved oxygen (Wodnicka, M. et al (2000) “Novel fluorescent technology platform for high throughput cytotoxicity and proliferation assays” J. Biomol. Screen. 5, 141-152) and others. However, as for the colourimetric assays discussed above, these do not directly report cell cycle parameters and have not been widely adopted.

All of the above methods provide data on the overall proliferation within a cell population under examination, but do not identify the status of individual cells. Adaptation of these assays to imaging, for example by micro-autoradiography of [³H]— or [¹⁴C]-thymidine incorporation (Dormer, P. (1981) “Quantitative carbon-14 autoradiography at the cellular level: principles and application for cell kinetic studies” Histochem. J. 13, 161-171) or by immunocytochemical or immunofluorescence detection of BrdU (Dolbeare, F. (1995) “Bromodeoxyuridine: a diagnostic tool in biology and medicine, Part I: historical perspectives, histochemical methods and cell kinetics” Histochem. J. 27, 339-369) permits identification of cells that have traversed S phase, but does not yield information on the cell cycle position of other cells under analysis.

To determine the cell cycle status of all cells in a population it is a prerequisite that the analytical technique can resolve at least to the level of a single cell. Of the two qualifying techniques available, flow cytometry and microscopy, flow cytometry has become firmly established as the standard method for analysing cell cycle distribution.

The DNA content of cell nuclei varies through the cell cycle in a predictable fashion—cells in G2 or M have twice the DNA content of cells in G1, and cells undergoing DNA synthesis in S phase have an intermediate amount of DNA. Consequently, staining of cellular DNA with propidium iodide (Nairn, R. C. and Rolland, J. M. (1980) “Fluorescent probes to detect lymphocyte activation” Clin. Exp. Immunol. 39, 1-13) or other fluorescent dyes (Smith, P. J. et al (2000) “Characteristics of a novel deep red/infrared fluorescent cell-permeant DNA probe, DRAQ5, in intact human cells analyzed by flow cytometry, confocal and multiphoton microscopy” Cytometry 40, 280-291) that are compatible with live cells, followed by flow cytometry permits measurement of the relative proportion of cells in G1, S and G2/M phases. However, analysis by propidium iodide staining and flow cytometry is necessarily destructive and hence requires multiple samples to study cell cycle progression, which can become rate limiting where many hundreds of samples are to be analysed. In addition, flow cytometry does not yield fine resolution of cell cycle position in G2/M as the DNA content is the same in all cells.

A combination of DNA staining with pulsed BrdU incorporation (Dolbeare, F. et al. (1983) “Flow cytometric measurement of total DNA content and incorporated bromodeoxyuridine” Proc. Natl. Acad. Sci. U.S.A. 80, 5573-5577) can be used to resolve the cell cycle position further. Dual-parameter analysis of DNA staining and/or BrdU incorporation can also be used with antibodies to cell-surface markers to profile cell cycle distribution in a defined sub-population of cells (Mehta, B. A. and Maino, V. C. (1997) “Simultaneous detection of DNA synthesis and cytokine production in staphylococcal enterotoxin B activated CD4⁺T lymphocytes by flow cytometry” J. Immunol. Methods 208, 49-59; Johannisson, A. et al. (1995) “Activation markers and cell proliferation as indicators of toxicity: a flow cytometric approach” Cell Biol. Toxicol. 11, 355-366; Penit, C. and Vasseur, F. (1993) “Phenotype analysis of cycling and postcycling thymocytes: evaluation of detection methods for BrdUrd and surface proteins” Cytometry 14, 757-763).

Although to date flow cytometry has remained the dominant method for analysing the cell cycle, many of the above techniques have also been applied to microscopic analyses (Gorczyca, W. et al. (1996) “Laser scanning cytometer (LSC) analysis of fraction of labeled mitoses. (FLM)” Cell Prolif. 29, 539-547; Clatch, R. J. and Foreman, J. R. (1998) “Five-colour immunophenotyping plus DNA content, analysis by laser scanning cytometry” Cytometry 34, 36-38).

The techniques described above all provide information in various forms from a single point in time (e.g. propidium iodide staining for DNA content) or integrated over a period of time (e.g. thymidine or BrdU incorporation). One further technique, cell-division tracking (Nordon, R. E. et al. (1999) “Analysis of growth kinetics by division tracking” Immunol. Cell Biol. 77, 523-529; Lyons, A. B. (1999) “Divided we stand: tracking cell proliferation with carboxyfluorescein diacetate succinimidyl ester” Immunol. Cell. Biol. 77, 509-515), allows the replicative history of a cell population to be analysed. In this method cells are loaded with a fluorescent dye such as carboxy-fluorescein diacetate succinimidyl ester (CFSE), which is partitioned between daughter cells at each successive round of cell division with a twofold reduction in fluorescence. Subsequent analysis of cell fluorescence by flow cytometry reveals the number of cell divisions undergone by each cell in the population. This technique has also been used in multi-parameter analyses combined with BrdU and proliferation-marker staining (Hasbold, J. and Hodgkin, P. D. (2000) “Flow cytometric cell division tracking using nuclei” Cytometry 40, 230-237).

International patent application WO 01/11341 describes a method for the automated measurement of the mitotic index of cells using fluorescence imaging. The technique involves immunoflourescence which reports specifically on mitotic cells by a signal emitted from the nuclei thereof By detecting the number of mitotic cells compared with the number of nuclei detected in a separate fluorescence channel, the mitotic index is determined. The technique involves simply counting cells having a signal above a given threshold, and is unsuited for the detection of cell cycle phases other than mitosis.

The application of GFP and imaging techniques to cell cycle analysis has enabled significant advances to be made in understanding the timing of the molecular events that control the cell cycle. Fusing GFP with key cell-cycle-control proteins (Raff, J. W. et al (2002) “The roles of Fzy/Cdc20 and Fzr/Cdh1 in regulating the destruction of cyclin B in space and time” J. Cell Biol. 157, 1139-1149; Zeng, Y. et al. (2000) “Minimal requirements for the nuclear localization of p27(Kip1), a cyclin-dependent kinase inhibitor” Bicohem. Biophys. Res. Commun. 274, 3742; Huang, J. and Raff. J. W. (1999) “The disappearance of cyclin B at the end of mitosis is regulated spatially in Drosophila cells” EMBO J. 18, 2184-2195; Weingartner, M. et al. (2001) “Dynamic recruitment of Cdc2 to specific microtubule structures during mitosis” Plant Cell 13, 1929-1943; Arnaud, L. et al. (1998) “GFP tagging reveals human Polo-like kinase 1 at the kinetochore/centromere region of mitotic chromosomes” Chromosoma 107, 424-429) and other cellular components (Kanda, T. et al. (1998) “Histone-GFP fusion protein enables sensitive analysis of chromosome dynamics in living mammalian cells” Curr. Biol. 8, 377-385; Reits, E. A. et al. (1997) “Dynamics of proteasome distribution in living cells” EMBO J. 16, 6087-6094; Tatebe, H. et al. (2001) “Fission yeast living mitosis visualized by GFP-tagged gene products” Micron 32, 67-74) has provided significant insights into the molecular organisation behind the cell cycle. However, although these specialised approaches provide valuable data on the mechanisms and components involved, they are not generic methods for monitoring the cell cycle.

### SUMMARY OF THE INVENTION

In accordance with an embodiment of the invention, there is provided a method of determining cell cycle phase data for cells comprising at least one luminescent reporter capable of emitting radiation, the at least one luminescent reporter comprising a first luminescent reporter which is capable of being indicative of at least one cell cycle phase, said method comprising:

storing classification information for classifying individual cells into different cell cycle phases using an automated classification process;

receiving image data created by detecting radiation emitted by said at least one luminescent reporter;

analyzing said image data to identify object areas in the image data which correspond to individual cells;

analyzing said image data, on the basis of said identified object areas, to determine, for a selected cell, one or more measurements including a measurement of a parameter relating to at least a cytoplasmic component of the cell; and

applying said classification information to said measurements to classify the selected cell into a selected one of a plurality of sub-populations of cells, each sub-population having cells in a different cell cycle phase.

The invention provides methods of analysis of luminescent imaging on cell populations in a manner that is rapid and versatile for use in high throughput compound screening.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic view of a first embodiment of a line-scan confocal microscope used to image samples according to the present invention.

FIGS. 2A and 2B are, respectively, a top view and a side view of the ray path of a multicolour embodiment of the present invention, without a scanning mirror. FIG. 2C is a top view of the ray path of a single beam autofocus.

FIGS. 3A and 3B are, respectively, a top view and a side view of the ray path of the multicolour embodiment of the present invention with the scanning mirror. FIG. 3C is a top view of the ray path of the single beam autofocus.

FIG. 4 is a side view of the two beam autofocus system.

FIGS. 5A, 5B and 5C illustrate a rectangular CCD camera and readout register.

FIG. 6 is a schematic illustration showing data processing components in an imaging a data processing system arranged in accordance with an embodiment of the invention.

FIG. 7 is a schematic diagram illustrating cell cycle position nucleic acid reporter constructs used in an embodiment of the present invention.

FIG. 8 shows a DNA construct for determining the G2/M phase of the cell cycle.

FIG. 9 is a schematic diagram illustrating cyclin B1 regulation during cell cycle progression. The cell cycle proceeds in the direction of the arrow with cyclin B1 expression driven by a cell cycle phase-specific promoter which initiates expression at the end of the S phase and peaks during G2 (A). At the start of mitosis (B) cyclin B1 translocates from the cytoplasm to the nucleus and from metaphase onwards (C) the protein is specifically degraded.

FIG. 10 is a schematic illustration showing typical intensity and distribution of signals in a cell including a fluorescent reporter in accordance with an embodiment of the invention, in each of the G0/G1, S, G2 and Mitotic (M) cell cycle phases.

FIG. 11 shows a set of pie graphs illustrating the relative sizes of the sub-populations of cells in each of the G0/G1/S, G2, Prophase and Mitotic cell cycle phases, as determined using an automated analysis in accordance with the invention, in each of an unsynchronized cell population, a colchicine treated cell population and a mimosine treated cell population.

FIG. 12 shows a graph illustrating the locations of different cell cycle phases relative to thresholds set in a third embodiment of the invention.

FIG. 13 is a schematic illustration showing typical intensity and distribution of signals in a cell including a fluorescent reporter in accordance with an embodiment of the invention, in each of the metaphase, anaphase, telophase, and cytokinesis cell cycle phases.

### DETAILED DESCRIPTION OF THE INVENTION

The present invention is useful for identifying pharmacological agents for the treatment of disease. It provides a high throughput method for conducting a wide variety of biological assays where one or more luminescent markers are employed to measure a biological response. Such assays can be conducted on chemical compounds or any molecule of biological interest, included but not limited to drug candidates, such as those found in combinatorial libraries will allow the high throughput screening of chemical compounds of biological interest, including but not limited to drug candidates, such as those found in combinatorial libraries.

The techniques of the present invention may be used in assays in which data are acquired on individual cells, on a cellular or sub-cellular level, sufficiently rapidly so as to permit the acquisition of such data on a sufficient number of cells to constitute a statistically meaningful sample of the cell population.

These assays may make use of any known fluorophore or fluorescent label including but not limited to fluorescein, rhodamine, Texas Red, Amersham Corp. stains Cy3, Cy5, Cy5.5 and Cy7, Hoechst's nuclear stains and Coumarin stains. (See Haugland R. P. Handbook of Fluorescent Probes and Research Chemicals 6^{th} Ed., 1996, Molecular Probes, Inc., Eugene, Oreg.)

Optical Configuration

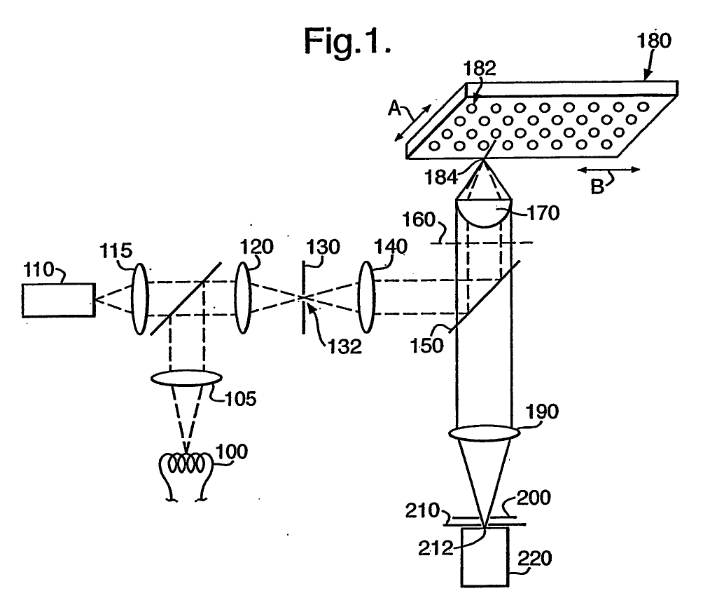

FIG. 1 shows a first embodiment of the present invention. The microscope comprises a source 100 or 110 of electromagnetic radiation for example, in the optical range, 350-750 nm, a cylindrical lens 120, a first slit mask 130, a first relay lens 140, a dichroic mirror 150, an objective lens 170, a microtiter plate 180 containing a two-dimensional array of sample wells 182, a tube lens 190, a filter 200, a second slit mask 210 and a detector 220. These elements are arranged along optical axis OA with slit apertures 132, 212 in masks 130, 210 extending perpendicular to the plane of FIG. 1. The focal lengths of lenses 140, 170 and 190 and the spacings between these lenses as well as the spacings between mask 130 and lens 140, between objective lens 170 and microtiter plate 180 and between lens 190 and mask 210 are such as to provide a confocal microscope. In this embodiment, electromagnetic radiation from a lamp 100 or a laser 110 is focused to a line using a cylindrical lens 120. The shape of the line is optimized by a first slit mask 130. The slit mask 130 is depicted in an image plane of the optical system, that is in a plane conjugate to the object plane. The illumination stripe formed by the aperture 132 in the slit mask 130 is relayed by lens 140, dichroic mirror 150 and objective lens 170 onto a microtiter plate 180 which contains a two-dimensional array of sample wells 182. For convenience of illustration, the optical elements of FIG. 1 are depicted in cross-section and the well plate in perspective. The projection of the line of illumination onto well plate 180 is depicted by line 184 and is also understood to be perpendicular to the plane of FIG. 1. As indicated by arrows A and B, well plate 180 may be moved in two dimensions (X, Y) parallel to the dimensions of the array by means not shown.

In an alternative embodiment, the slit mask 130 resides in a Fourier plane of the optical system, that is in a plane conjugate to the objective back focal plane (BFP) 160. In this case the aperture 132 lies in the plane of the figure, the lens 140 relays the illumination stripe formed by the aperture 132 onto the back focal plane 160 of the objective 170 which transforms it into a line 184 in the object plane perpendicular to the plane of FIG. 1.

In an additional alternative embodiment the slit mask 130 is removed entirely. According to this embodiment, the illumination source is the laser 110, the light from which is focused into the back focal plane 160 of the objective 170. This can be accomplished by the combination of the cylindrical lens 120 and the spherical lens 140 as shown in FIG. 1, or the illumination can be focused directly into the plane 160 by the cylindrical lens 120.

An image of the sample area, for example a sample in a sample well 182, is obtained by projecting the line of illumination onto a plane within the sample, imaging the fluorescence emission therefrom onto a detector 220 and moving the plate 180 in a direction perpendicular to the line of illumination, synchronously with the reading of the detector 220. In the embodiment depicted in FIG. 1, the fluorescence emission is collected by the objective lens 170, projected through the dichroic beamsplitter 150, and imaged by lens 190 through filters 200 and a second slit mask 210 onto a detector 220, such as is appropriate to a confocal imaging system having an infinity-corrected objective lens 170. The dichroic beamsplitter 150 and filter 200 preferentially block light at the illumination wavelength. The detector 220 illustratively is a camera and may be either one dimensional or two dimensional. If a one dimensional detector is used, slit mask 210 is not needed. The illumination, detection and translation procedures are continued until the prescribed area has been imaged. Mechanical motion is simplified if the sample is translated at a continuous rate. Continuous motion is most useful if the camera read-time is small compared to the exposure-time. In a preferred embodiment, the camera is read continuously. The displacement d of the sample during the combined exposure-time and read-time may be greater than or less than the width of the illumination line W, exemplarily 0.5W≦d≦5W. All of the wells of a multiwell plate can be imaged in a similar manner.

Alternatively, the microscope can be configured to focus a line of illumination across a number of adjacent wells, limited primarily by the field-of-view of the optical system. Finally, more than one microscope can be used simultaneously.

The size and shape of the illumination stripe 184 is determined by the width and length of the Fourier transform stripe in the objective lens back focal plane 160. For example, the length of the line 184 is determined by the width of the line in 160 and conversely the width in 184 is determined by the length in 160. For diffraction-limited performance, the length of the illumination stripe at 160 is chosen to overfill the objective back aperture. It will be evident to one skilled in the art that the size and shape of the illumination stripe 184 can be controlled by the combination of the focal length of the cylindrical lens 120 and the beam size at 120, that is by the effective numerical aperture in each dimension, within the restrictions imposed by aberrations in the objective, and the objective field of view.

The dimensions of the line of illumination 184 are chosen to optimize the signal to noise ratio. Consequently, they are sample dependent. Depending on the assay, the resolution may be varied between diffraction-limited, i.e., less than 0.5 μm, and approximately 5 μm. The beam length is preferably determined by the objective field of view, exemplarily between 0.5 and 1.5 mm. A Nikon ELWD, 0.6 NA, 10× objective, for example, has a field of view of approximately 0.75 mm. The diffraction-limited resolution for 633 nm radiation with this objective is approximately 0.6 μm or approximately 1100 resolution elements.

The effective depth resolution is determined principally by the width of aperture 212 in slit mask 210 or the width of the one dimensional detector and the image magnification created by the combination of the objective lens 170 and lens 190. The best depth resolution of a confocal microscope approaches 1 μm. In the present application, a depth resolution of 5-10 μm may be sufficient or even advantageous.

For example, when the sample of interest, such as a live cell, contains insufficient fluorophores in a diffraction-limited volume to permit an adequate signal-to-noise image in a sufficiently brief image-acquisition time, it is advantageous to illuminate and collect the emission from a larger than diffraction-limited volume. A similar situation prevails in the case of video-rate kinetics studies of transient events such as ion-channel openings. Practically, this is accomplished by underfilling the back aperture of the objective lens, which is equivalent to increasing the diameter of the illumination aperture. The effective numerical aperture (“NA”) of the illumination is less than the NA of the objective. The fluorescence emission is, however, collected with the full NA of the objective lens. The width of aperture 212 must be increased so as to detect emission from the larger illumination volume. At an aperture width a few times larger than the diffraction limit, geometrical optics provides an adequate approximation for the size of the detection-volume element:
Lateral Width: a_{d}=d_{d}/M,
Axial Width: z_{d}=\sqrt{2}a_{d}√tan α,
where M is the magnification, d_{d} is the width of aperture 212 and α is the half-angle subtended by the objective 170. It is an important part of the present invention that the illumination aperture 132 or its equivalent in the embodiment having no aperture and the detection aperture 212 be independently controllable.
Multi-Wavelength Configuration

An embodiment enabling multi-wavelength fluorescence imaging is preferred for certain types of assays. In this way, image data can be generated for the same area being imaged in each of a plurality of different colour channels simultaneously.

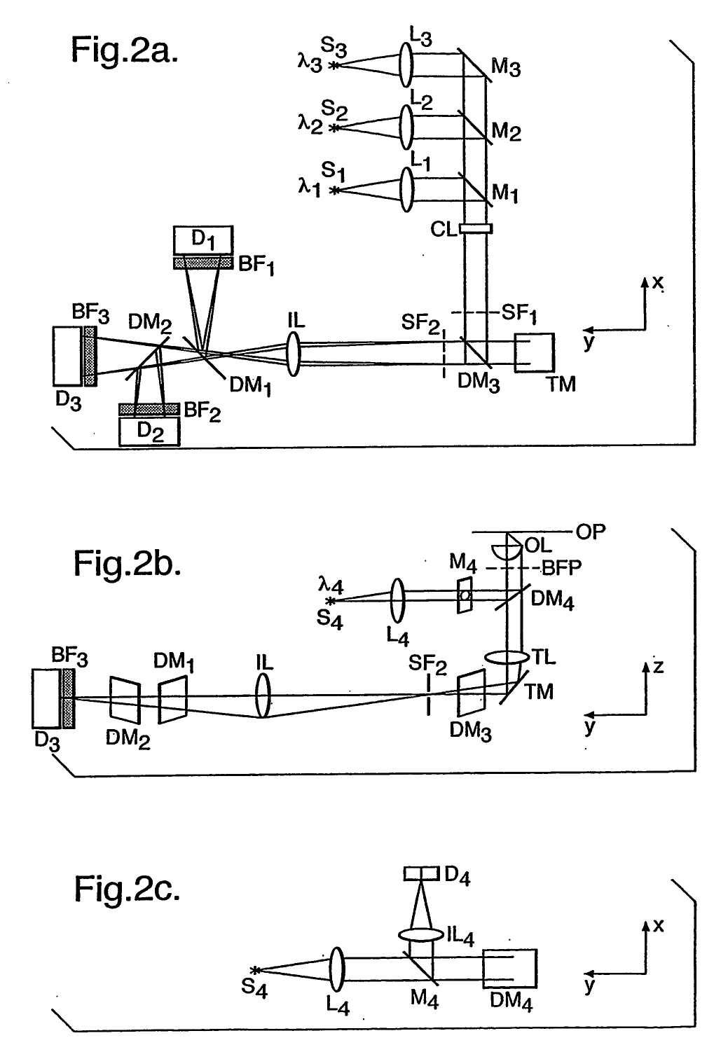

The number of independent wavelengths or colours will depend on the specific assay being performed. In one embodiment three illumination wavelengths are used. FIGS. 2A and 2B depict the ray paths in a three-colour line-scan confocal imaging system, from a top view and a side view respectively. In general, the system comprises several sources Sₙ of electromagnetic radiation, collimating lenses Lₙ, and mirrors Mₙ for producing a collimated beam that is focused by cylindrical lines CL into an elongated beam at first spatial filter SF₁, a confocal microscope between first spatial filter SF₁, and second spatial filter SF₂ and an imaging lens IL, beamsplitters DM_{I} and DM₂ and detectors Dₙ for separating and detecting the different wavelength components of fluorescent radiation from the sample. Spatial filters SF, and SF₁ and SF₂ preferably are slit masks.

In particular, FIG. 2A depicts sources, S₁, S₂ and S₃, for colours λ₁, λ₂ and λ₃, and lenses L₁, L₂ and L₃ that collimate the light from the respective sources. Lenses L₁, L₂ and L₃, preferably are adjusted to compensate for any chromaticity of the other lenses in the system. Mirrors M₁, M₂ and M₃ are used to combine the illumination colours from sources Sₙ. The mirrors M₂ and M₁ are partially transmitting, partially reflecting and preferentially dichroic. M₂, for example, should preferentially transmit λ₃, and preferentially reflect λ₂. It is thus preferential that λ₃ be greater than λ₂.

Operation of the microscope in a confocal mode requires that the combined excitation beams from sources Sₙ be focused to a “line”, or an highly eccentric ellipse, in the object plane OP. As discussed in connection to FIG. 1 above, a variety of configurations may be used to accomplish this. In the embodiment depicted in FIG. 2, the combined illumination beams are focused by cylindrical lens CL into an elongated ellipse that is coincident with the slit in the spatial filter SF₁. As drawn in FIGS. 2A and 2B, the slit mask SF₁ resides in an image plane of the system, aligned perpendicular to the propagation of the illumination light and with its long axis in the plane of the page of FIG. 2A. The lenses TL and OL relay the illumination line from the plane containing SF₁ to the object plane OP. A turning mirror, TM, is for convenience. In another embodiment, DM₃ is between TL and OL and CL focuses the illumination light directly into the BFP. Other embodiments will be evident to one skilled in the art.

Referring to FIG. 2B, the light emitted by the sample and collected by the objective lens, OL, is imaged by the tube lens, TL, onto the spatial filter, SF₂. SF₂ is preferentially a slit aligned so as to extend perpendicular to the plane of the page. Thus, the light passed by filter SF₂ is substantially a line of illumination. SF₂ may be placed in the primary image plane or any plane conjugate thereto. DM₃ is partially reflecting, partially transmitting and preferably “multichroic”. Multi-wavelength “dichroic” mirrors, or “multichroic” mirrors can be obtained that preferentially reflect certain wavelength bands and preferentially transmit others.

Here, δπ₁ will be defined to be the fluorescence emission excited by λ₁. This will, in general, be a distribution of wavelengths somewhat longer than λ₁. δλ₂ and δλ₃ are defined analogously. DM₃ preferentially reflects λₙ, and preferentially transmits δλₙ, n=1,2,3. The light transmitted by SF₂ is imaged onto the detection devices, which reside in planes conjugate to the primary image plane. In FIG. 2A, an image of the spatial filter SF₂ is created by lens IL on all three detectors, Dₙ. This embodiment is preferred in applications requiring near-perfect registry between the images generated by the respective detectors. In another embodiment, individual lenses ILₙ are associated with the detection devices, the lens pairs IL and ILₙ serving to relay the image of the spatial filter SF₂ onto the respective detectors Dₙ. The light is split among the detectors by mirrors DM₁ and DM₂. The mirrors are partially transmitting, partially reflecting, and preferentially dichroic. DM₁ preferentially reflects δλ₁ and preferentially transmits δλ₂ and δλ₃. The blocking filter, BF₁, preferentially transmits δλ₁ effectively blocking all other wavelengths present. DM₂ preferentially reflects δλ₂ and preferentially transmits δλ₃. The blocking filters, BF₂ and BF₃, preferentially transmit δλ₂ and δλ₃ respectively, effectively blocking all other wavelengths present.

Scanning Mirror Configuration

In some embodiments of this invention, rapid data acquisition is provided by framing images at video rates. Video-rate imaging allows up to 30 or even 60 frames per second. In the present use, it is intended to connote frame rates with an order-of-magnitude of 30 Hz. In a preferred embodiment, video-rate imaging is achieved by illuminating along one dimension of the sample plane and scanning the illumination beam in the direction perpendicular thereto so as to effect a relative translation of the illumination and sample. The scanning stage is generally massive. Consequently, it cannot be moved sufficiently rapidly.

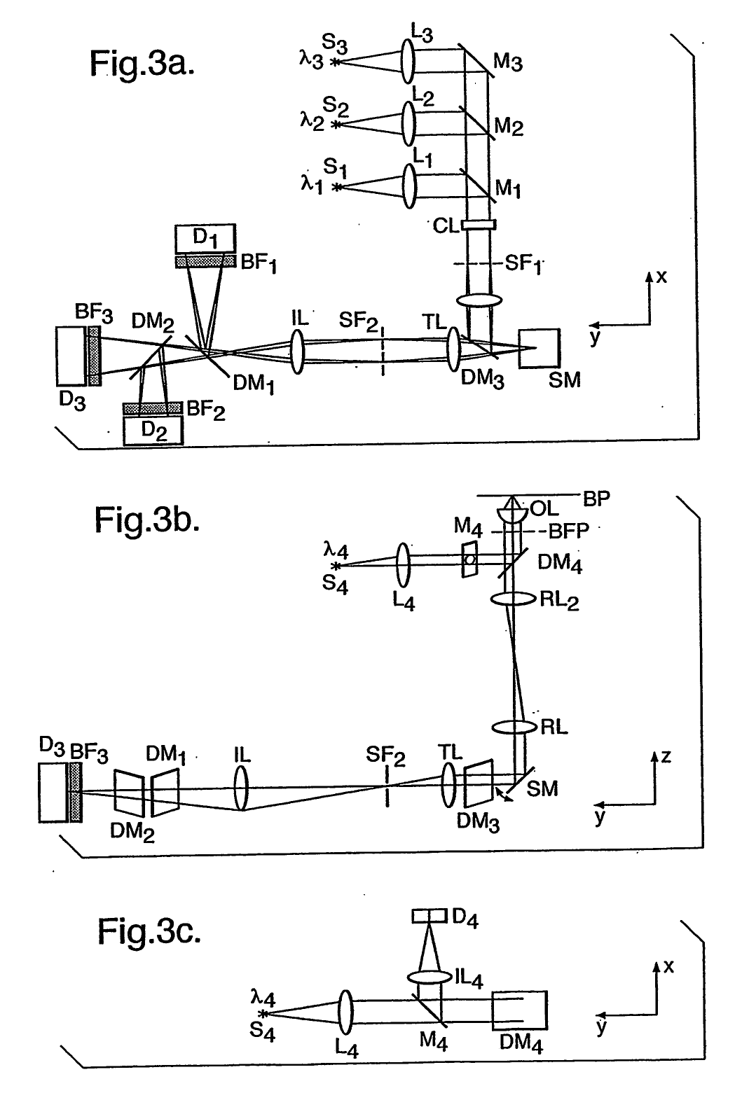

FIG. 3 depicts an embodiment of the invention utilizing a scanning mirror, SM. The mirror is advantageously placed in a plane conjugate to the objective back focal plane (BFP): A rotation in the BFP (or a plane conjugate thereto) effects a translation in the object plane (OP) and its conjugate planes. The full scan range of SM need only be a few degrees for typical values of the focal lengths of the lenses RL₁ and RL₂. As shown in FIG. 3, this lens pair images the BFP onto the SM at a magnification of one, but a variety of magnifications can be advantageously used. The limiting factors to the image acquisition rate are the camera read-rate and the signal strength. In the imaging mode described above, data can be acquired continuously at the camera read-rate, exemplarily 1 MHz With a scanning mirror, it is preferable to acquire data uni-directionally. The idealized scanning motion allowing one to acquire data continuously is the sawtooth. In practice, the combination of turn-around and return scan times will constitute ˜⅓-⅔ of the scan period. Assuming 50% dead-time, a mirror oscillation frequency of 50 Hz and a pixel acquisition rate of 1 MHz, ˜10,000 pixels would be acquired per frame at 50 frames per second, which is sufficient to define and track individual objects, such as cells, from frame to frame. 10⁴ pixels per image is, however, 10²-times fewer than was generally considered above. Depending on the application, it is advantageous to acquire relatively smaller images at high resolution, e.g. 50-μm×50-μm at 0.5-μm×0.5-μm pixelation, or relatively larger images at lower resolution, e.g. 200-μm×200-μm at 2-μm pixelation.

Autofocus

In preferred embodiments of the present invention, the sample lies in the object plane of an imaging system. Accordingly, an autofocus mechanism is used that maintains the portion of the sample in the field-of-view of the imaging system within the object plane of that system. The precision of planarity is determined by the depth-of-field of the system. In a preferred embodiment, the depth-of-field is approximately 10 μm and the field-of-view is approximately 1 mm².

The autofocus system operates with negligible delay, that is, the response time is short relative to the image acquisition-time, exemplarily 0.01-0.1 s. In addition, the autofocus light source is independent of the illumination light sources and the sample properties. Among other advantages, this configuration permits the position of the sample carrier along the optical axis of the imaging system to be determined independent of the position of the object plane.

Embodiments of single-beam autofocus are shown in FIGS. 2C and 3C, where a separate light source, S₄ of wavelength λ₄, and detector D₄ are shown. The wavelength λ₄ is necessarily distinct from the sample fluorescence, and preferentially a wavelength that cannot excite appreciable fluorescence in the sample. Thus, λ₄ is preferentially in the near infrared, exemplarily 800-1000 nm. The partially transmitting, partially reflecting mirror, DM₄, is preferentially dichroic, reflecting λ4 and transmitting λₙ and δλₙ, n=1,2,3. Optically-based autofocus mechanisms suitable for the present application are known. For example, an astigmatic-lens-based system for the generation of a position error signal suitable for servo control is disclosed in Applied Optics 23 565-570 (1984). A focus error detection system utilizing a “skew beam” is disclosed in SPIE 200 73-78 (1979). The latter approach is readily implemented according to FIGS. 2C and 3C, where D₄ is a split detector.

For use with a microtiter plate having a sample residing on the well bottom, the servo loop must, however, be broken to move between wells. This can result in substantial time delays because of the need to refocus each time the illumination is moved to another well.

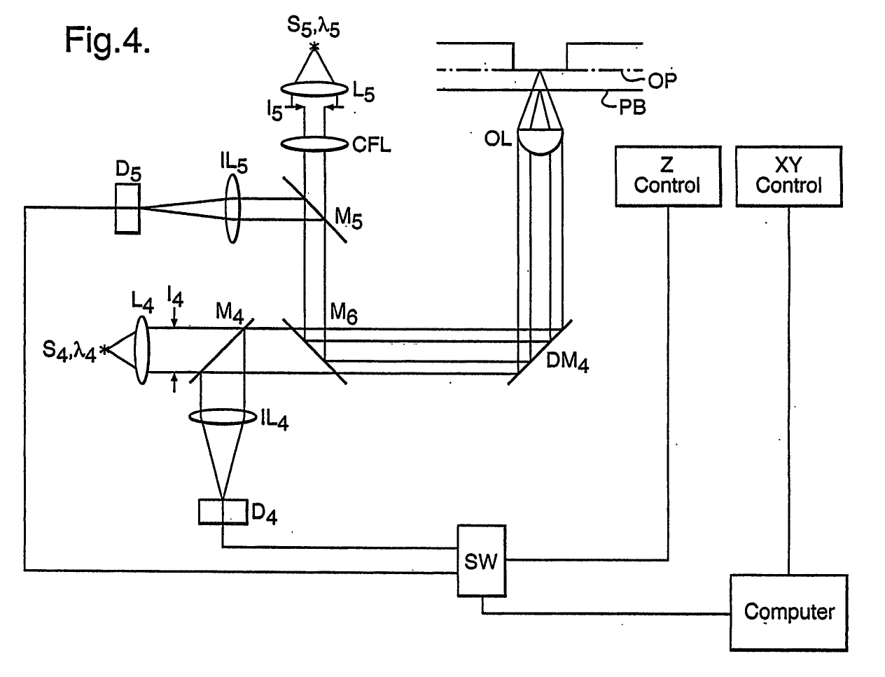

Continuous closed-loop control of the relative position of the sample plane and the object plane is provided in a preferred embodiment of the present invention, depicted in FIG. 4. This system utilizes two independent beams of electromagnetic radiation. One, originating from S₅, is focused on the continuous surface, exemplarily the bottom of a microtiter plate. The other, originating from S₄, is focused on the discontinuous surface, exemplarily the well bottom of a microtiter plate. In one embodiment, the beams originating from S₄ and S₅ have wavelengths λ₄ and λ₅, respectively. λ₄ is collimated by L₄, apertured by iris I₄, and focused onto the discontinuous surface by the objective lens OL. λ₅ is collimated by L₅, apertured by iris I₅, and focused onto the continuous surface by the lens CFL in conjunction with the objective lens OL. The reflected light is focused onto the detectors D₄ and D₅ by the lenses IL₄ and IL₅, respectively. The partially transmitting, partially reflecting mirror, DM₄, is preferentially dichroic, reflecting λ₄ and λ₅ and transmitting λₙ and δλₙ, n=1,2,3. The mirrors, M₄, M₅ and M₆, are partially transmitting, partially reflecting. In the case that λ₄ and λ₅ are distinct, M₆ is preferentially dichroic.

According to the embodiment wherein the sample resides in a microtiter plate, λ₄ is focused onto the well bottom. The object plane can be offset from the well bottom by a variable distance. This is accomplished by adjusting L₄ or alternatively by an offset adjustment in the servo control loop. For convenience of description, it will be assumed that λ₄ focuses in the object plane.

The operation of the autofocus system is as follows. If the bottom of the sample well is not in the focal plane of objective lens OL, detector D₄ generates an error signal that is supplied through switch SW to the Z control. The Z control controls a motor (not shown) for moving the microtiter plate toward or away from the objective lens. Alternatively, the Z control could move the objective lens. If the bottom PB of the microtiter plate is not at the focal plane of the combination of the lens CFL and the objective lens OL, detector D₅ generates an error signal that is applied through switch SW to the Z control. An XY control controls a motor (not shown) for moving the microtiter plate in the object plane OP of lens OL.

As indicated, the entire scan is under computer control. An exemplary scan follows: At the completion of an image in a particular well, the computer operates SW to switch control of the servo mechanism from the error signal generated by D₄ to that generated by D₅; the computer then directs the XY control to move the plate to the next well, after which the servo is switched back to D₄.

The “coarse” focusing mechanism utilizing the signal from the bottom of the plate is used to maintain the position of the sample plane to within the well-to-well variations in the thickness of the plate bottom, so that the range over which the “fine” mechanism is required to search is minimized. If, for example, the diameter of the iris I₅ is 2 mm and IL₅ is 100 mm, then the image size on the detector will be ˜100 μm. Similarly, if the diameter of the iris I₄ is 0.5 mm and IL₄ is 100 mm, then the image size on the detector will be ˜400 μm. The latter is chosen to be less sensitive so as to function as a “coarse” focus.

As with the single-beam embodiment described above, the wavelengths λ₄ and λ₅ are necessarily distinct from the sample fluorescence, and preferentially wavelengths that cannot excite appreciable fluorescence in the sample. Thus, λ₄ and λ₅ are preferentially in the near infrared, such as 800-1000 nm. In addition, the two wavelengths are preferably distinct, for example λ₄=830 nm, λ₅=980 nm.

In an alternative embodiment of two-beam autofocus, λ₄=λ₅ and the two beams may originate from the same source. Preferentially, the two beams are polarized perpendicular to one another and M₆ is a polarizing beamsplitter.

Pseudo-closed loop control is provided in the preferred embodiment of single-beam autofocus which operates as follows. At the end of a scan the computer operates SW to switch control to a sample-and-hold device which maintains the Z control output at a constant level while the plate is moved on to the next well after which SW is switched back to D₄.

Detection Devices

A detection device is used having manifold, independent detection elements in a plane conjugate to the object plane. As discussed above, line illumination is advantageous principally in applications requiring rapid imaging. The potential speed increase inherent in the parallelism of line illumination as compared to point illumination is, however, only realized if the imaging system is capable of detecting the light emitted from each point of the sample along the illumination line, simultaneously.

It is possible to place a charge-coupled device (CCD), or other camera, at the output of the prior art imaging systems described above (White et al., U.S. Pat. No. 5,452,125 and Brakenhoff and Visscher, J. Microscopy 171 17-26 (1993)). The resulting apparatus has three significant disadvantages compared to the present invention. One is the requirement of rescanning the image onto the two-dimensional detector, which adds unnecessary complexity to the apparatus. Another is the requirement of a full two-dimensional detector having sufficient quality over the 1000 pixel×1000 pixel array that typically constitutes the camera. The third disadvantage is the additional time required to read the full image from the two-dimensional device.

To avoid these disadvantages and optimize not only imaging speed, within the constraints of high-sensitivity and low-noise detection, but also throughput, a continuous-read line-camera is used and in a preferred embodiment a rectangular CCD is used as a line-camera Both embodiments have no dead-time between lines within an image or between images. An additional advantage is that a larger effective field-of-view is achievable in the stage-scanning embodiment, discussed below.

The properties required of the detection device can be further clarified by considering the following preferred embodiment. The resolution limit of the objective lens is <1 μm, typically ˜0.5 μm, and the detector comprises an array of ˜1000 independent elements. Resolution, field-of-view (FOV) and image acquisition-rate are not independent variables, necessitating compromise among these performance parameters. In general, the magnification of the optical system is set so as to image as large a FOV as possible without sacrificing resolution. For example, a ˜1 mm field-of-view could be imaged onto a 1000-element array at 1-μm pixelation. If the detection elements are 20-μm square, then the system magnification would be set to 20×. Note that this will not result in 1-μm resolution. Pixelation is not equivalent to resolution. If, for example, the inherent resolution limit of the objective lens is 0.5 μm and each 0.5 μm×0.5 μm region in the object plane is mapped onto a pixel, the true resolution of the resulting digital image is not 0.5 μm. To achieve true 0.5-μm resolution, the pixelation would need to correspond to a region ˜0.2 μm×0.2 μm in the object plane. In one preferred embodiment, the magnification of the imaging system is set to achieve the true resolution of the optics.

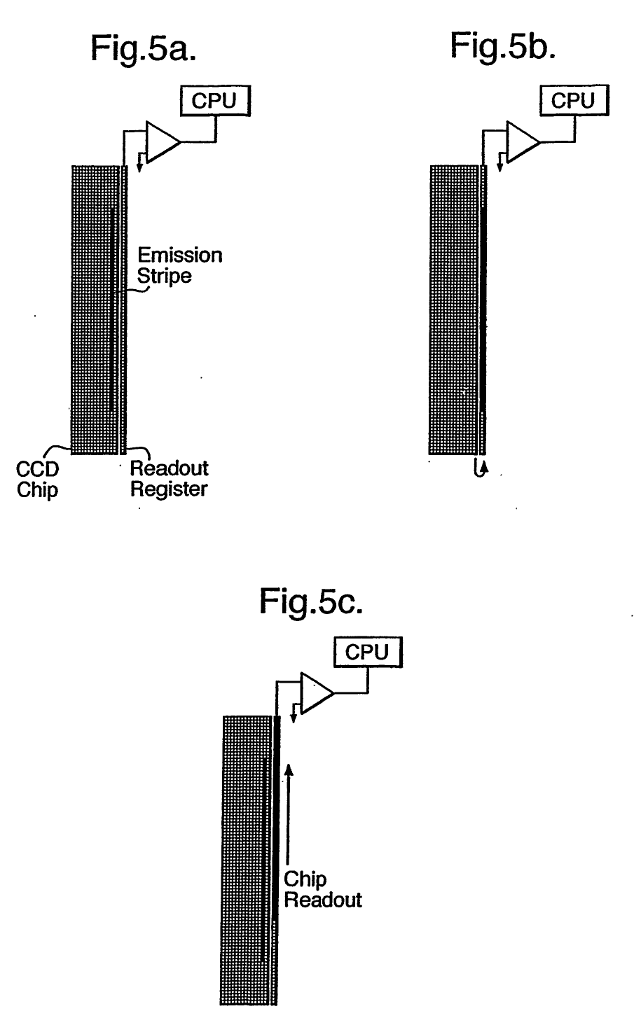

Presently, the highest detection efficiency, lowest noise detection devices having sufficient read-out speed for the present applications are CCD cameras. In FIG. 5, a rectangular CCD camera is depicted having an m×n array of detector elements where m is substantially less than n. The image of the fluorescence emission covers one row that is preferably proximate to the read register. This minimizes transfer time and avoids accumulating spurious counts into the signal from the rows between the illuminated row and the read-register.

In principle, one could set the magnification of the optical system so that the height of the image of the slit SF₂ on the CCD camera is one pixel, as depicted in FIG. 5. In practice, it is difficult to maintain perfect alignment between the illumination line and the camera row-axis, and even more difficult to maintain alignment among three cameras and the illumination in the multi-wavelength embodiment as exemplified in FIGS. 2 and 3. By binning together a few of the detector elements, exemplarily two to five, in each column of the camera the alignment condition can be relaxed while suffering a minimal penalty in read-noise or read-time.

An additional advantage of the preferred embodiment having one or more rectangular CCD cameras as detection devices in conjunction with a variable-width detection spatial filter, SF₂ in FIGS. 2 and 3 and 210 in FIG. 1, each disposed in a plane conjugate to the object plane, is elucidated by the following. As discussed above, in one embodiment of the present invention the detection spatial filter is omitted and a line-camera is used as a combined detection spatial filter and detection device. But as was also discussed above, a variable-width detection spatial filter permits the optimization of the detection volume so as to optimize the sample-dependent signal-to-noise ratio. The following preferred embodiment retains the advantage of a line-camera, namely speed, and the flexibility of a variable detection volume. The magnification is set so as to image a diffraction-limited line of height h onto one row of the camera. The width of the detection spatial filter d is preferably variable h≦d ≦10 h. The detectors in the illuminated columns of the camera are binned, prior to reading, which is an operation that requires a negligible time compared to the exposure- and read-times.

In one preferred embodiment, the cameras are Princeton Instruments NTE/CCD-1340/100-EMD. The read-rate in a preferred embodiment is 1 MHz at a few electrons of read-noise. The pixel format is 1340×100, and the camera can be wired to shift the majority of the rows (80%) away from the region of interest, making the camera effectively 1340×20.

In addition to the above mentioned advantage of a continuous read camera, namely the absence of dead-time between successive acquisitions, an additional advantage is that it permits the acquisition of rectangular images having a length limited only by the extent of the sample. The length is determined by the lesser of the camera width and the extent of the line illumination. In a preferred embodiment the sample is disposed on the bottom of a well in a 96-well microtiter plate, the diameter of which is 7 mm. A strip 1 μm×1 mm is illuminated and the radiation emitted from the illuminated area is imaged onto the detection device. The optical train is designed such that the field-of-view is ˜1 mm². According to the present invention, an image of the well-bottom can be generated at 1-μm pixelation over a 1×7-mm field.

Environmental Control

In an embodiment of the present invention, assays are performed on live cells. Live-cell assays frequently require a reasonable approximation to physiological conditions to run properly. Among the important parameters is temperature. It is desirable to incorporate a means to raise and lower the temperature, in particular, to maintain the temperature of the sample at 37° C. In another embodiment, control over relative humidity, and/or CO₂ and/or O₂ is necessary to maintain the viability of live cells. In addition, controlling humidity to minimize evaporation is important for small sample volumes.

Three embodiments providing a microtiter plate at an elevated temperature, preferably 37° C., compatible with the LCI system follow.

The imaging system preferably resides within a light-proof enclosure. In a first embodiment, the sample plate is maintained at the desired temperature by maintaining the entire interior of the enclosure at that temperature. At 37° C., however, unless elevated humidity is purposefully maintained, evaporation cooling will reduce the sample volume limiting the assay duration.

A second embodiment provides a heated cover for the microwell plate which allows the plate to move under the stationary cover. The cover has a single opening above the well aligned with the optical axis of the microscope. This opening permits dispensing into the active well while maintaining heating and limited circulation to the remainder of the plate. A space between the heated cover plate and microwell plate of approximately 0.5 mm allows free movement of the microwell plate and minimizes evaporation. As the contents of the interrogated well are exposed to ambient conditions though the dispenser opening for at most a few seconds, said contents suffer no significant temperature change during the measurement.

In a third embodiment, a thin, heated sapphire window is used as a plate bottom enclosure. A pattern of resistive heaters along the well separators maintain the window temperature at the desired level.

In additional embodiments, the three disclosed methods can be variously combined.

In an additional preferred embodiment of the invention, employed in automated screening assays, the imaging system is integrated with plate-handling robots, such as the Zymark Twister.

Data Processing System

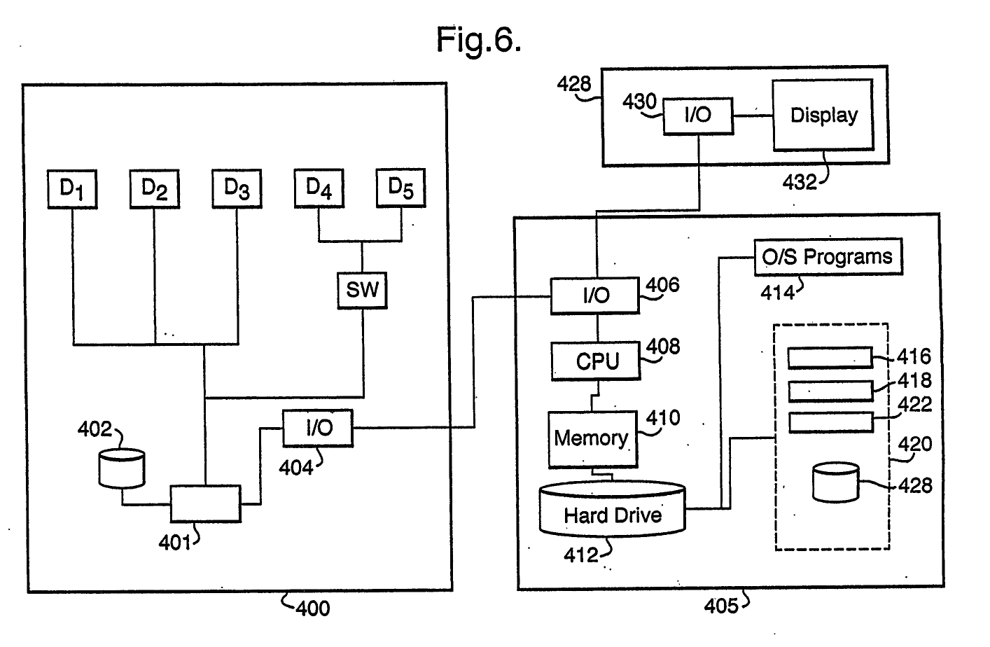

FIG. 6 shows a schematic illustration of data processing components of a system arranged in accordance with the invention. The system, based on the Amersham Biosciences IN Cell Analyzer™ system, includes a confocal microscope 400 as described above, which includes the detectors D₁, D₂, D₃, D₄, D₅, the switch SW, a control unit 401, an image data store 402 and an Input/Output (I/O) device 404. An associated computer terminal 405 includes a central processing unit (CPU) 408, memory 410, a data storage device such as a hard disc drive 412 and I/O devices 406 which facilitate interconnection of the computer with the MDPU and the computer with a display element 432 of a screen 428 via a screen I/O device 430, respectively. Operating system programs 414 are stored on the hard disc drive 412, and control, in a known manner, low level operation of the computer terminal 405. Program files and data 420 are also stored on the hard disc drive 412, and control, in a known manner, outputs to an operator via associated devices and output data stored on the hard disc drive. The associated devices include a display 432 as an element of the screen 428, a pointing device (not shown) and keyboard (not shown), which receive input from, and output information to, the operator via further I/O devices (not shown). Included in the program files 420 stored on the hard drive 412 are an image processing and analysis application 416, an assay control application 418, and a database 422 for storing image data received from the microscope 400 and output files produced during data processing. The image processing and analysis application 418 may be a customized version of known image processing and analysis software packages, such as Image-Pro™ from Media Cybernetics.

The performance of an assay using the confocal microscope 400 is controlled using control application 418, and the image data are acquired. After the end of acquisition of image data for at least one well in a microtiter plate by at least one detector D₁, D₂, D₃, the image data are transmitted to the computer 405 and stored in the database 422 on the computer terminal hard drive 412, at which point the image data can be processed using the image processing and analysis application 416, as will be described in greater detail below.

Luminescent Reporters Expressed in Cells

Numerous variations of the assay methods described below can be practiced in accordance with the invention. In general, a characteristic spatial and/or temporal distribution of one or more luminescence reporters in cells is used to quantify the assay. Advantageously, luminescence is observed from an essentially planar surface using a line-scan confocal microscope as described above.

In preferred embodiments of the invention, luminescent reporters are provided in a manner as described in our previous International patent application PCT/GB02/004258. The position in the cell cycle of a population of cells is determined by:

a) expressing in the cells a nucleic acid reporter construct, preferably a DNA construct, comprising a nucleic acid sequence encoding a detectable live-cell reporter molecule operably linked to and under the control of:
i) at least one cell cycle phase-specific expression control element, and
ii) a destruction control element;
wherein said reporter construct is expressed in a cell at a predetermined point in the cell cycle; and

b) determining the position of cells in the cell cycle by monitoring luminescent signals emitted by the reporter molecule.

The nucleic acid reporter construct is also preferably linked to and under the control of a cell cycle phase-specific spatial localisation control element.

The cell cycle phase-specific expression control element is typically a DNA sequence that controls transcription and/or translation of one or more nucleic acid sequences and permits the cell cycle specific control of expression. Any expression control element that is specifically active in one or more phases of the cell cycle may suitably be used for construction of the cycle position reporter construct.

Suitably, the cell cycle phase specific expression control element may be selected from cell cycle specific promoters and other elements that influence the control of transcription or translation in a cell cycle specific manner. Where the expression control element is a promoter, the choice of promoter will depend on the phase of the cell cycle selected for study.

Suitable promoters include: cyclin B1 promoter (Cogswell et al, Mol. Cell Biol., (1995), 15(5), 2782-90, Hwang et al, J. Biol. Chem., (1995), 270(47), 28419-24, Piaggio et al, Exp. Cell Res., (1995), 216(2), 396-402); Cdc25B promoter (Korner et al, J. Biol. Chem., (2001), 276(13), 9662-9); cyclin A2 promoter (Henglein et al, Proc. Nat. Acad. Sci. USA, (1994), 91(12), 5490-4, Zwicker et al, Embo J., (1995), 14(18), 4514-22); Cdc2 promoter (Tommasi and Pfeifer, Mol. Cell Biol., (1995), 15(12), 6901-13, Zwicker et al, Embo J (1995), 14(18), 4514-22), Cdc25C promoter (Korner and Muller, J. Biol. Chem., (2000), 275(25), 18676-81, Korner et al, Nucl. Acids Res., (1997), 25(24), 4933-9); cyclin E promoter (Botz et al, Mol. Cell Biol., (1996), 16(7), 3401-9, Korner and Muller, J. Biol. Chem., (2000), 275(25), 18676-81); Cdc6 promoter (Hateboer et al, Mol. Cell Biol., (1998), 18(11), 6679-97, Yan et al, Proc. Nat. Acad. Sci. USA, (1998), 95(7), 3603-8); DHFR promoter (Shimada et al, J. Biol. Chem., (1986), 261(3), 1445-52, Shimada and Nienhuis, J. Biol. Chem., (1985), 260(4), 2468-74) and histones promoters (van Wijnen et al, Proc. Nat. Acad. Sci. USA, (1994), 91, 12882-12886).

Suitably, the cell cycle phase specific expression control element may be selected from cell cycle specific IRES elements and other elements that influence the control of translation in a cell cycle specific manner. An IRES element is an internal ribosomal entry site that allows the binding of a ribosome and the initiation of translation to occur at a region of mRNA which is not the 5′-capped region. A cell cycle-specific IRES element restricts cap-independent initiation of translation to a specific stage of the cell cycle (Sachs, A. B., Cell, (2000), 101, 243-5). Where the expression control element is selected to be an IRES, suitably its selection will depend on the cell cycle phase under study. In this case, a constitutively expressed (e.g. CMV or SV40) or inducible (e.g. pTet-on pTet-off system, Clontech) promoter may be used to control the transcription of the bicistronic mRNA (Sachs, A. B., Cell, (2000), 101, 243-5). Alternatively, a non cell cycle phase-dependent IRES element (e.g. the EMCV IRES found in pIRES vectors, BD Clontech) may be used in conjunction with a cell cycle specific promoter element. Alternatively, more precise control of expression of the reporter may be obtained by using a cell cycle phase specific promoter in conjunction with a cell cycle phase specific IRES element.

IRES elements suitable for use in the invention include: G2-IRES (Cornelis et al, Mol. Cell, (2000), 5(4), 597-605); HCV IRES (Honda et al, Gastroenterology, (2000), 118 152-162); ODC IRES (Pyronet et al, Mol. Cell, (2000), 5, 607-616); c-myc IRES (Pyronnet et al, Mol. Cell, (2000), 5(4), 607-16) and p58 PITSLRE IRES (Cornelis et al, Mol. Cell, (2000), 5(4), 597-605).

Table 1 lists some preferred expression control elements that may be used in accordance with the invention, and indicates the cell cycle phase in which each element is activated.

TABLE 1
Cell Cycle Phase-Specific Expression Control Elements

| Element | Timing |
|---|---|
| Cyclin B1 promoter | G2 |
| Cdc25B promoter | S/G2 |
| Cyclin A2 promoter | S |
| Cdc2 promoter | S |
| Cdc25C promoter | S |
| Cyclin E promoter | late G1 |
| Cdc6 promoter | late G1 |
| DHFR promoter | late G1 |
| Histones promoters | late G1/S |
| G2-IRES | G2 |
| HCV IRES | M |
| ODC IRES | G2/M |
| c-myc IRES | M |
| p58 PITSLRE IRES | G2/M |

The destruction control element is a DNA sequence encoding a protein motif that controls the destruction of proteins containing that sequence. Suitably, the destruction control element may be cell cycle mediated, for example: Cyclin B1 D-box (Glotzer et al, Nature, (1991), 349, 132-138, Yamano et al, EMBO J., (1998), 17(19), 5670-8, Clute and Pines, Nature Cell Biology, (1999), 1, 82-87); cyclin A N-terminus (den Elzen and Pines, J. Cell Biol., (2001), 153(1), 121-36, Geley et al, J. Cell Biol., (2001), 153, 137-48); KEN box (Pfleger and Kirschner, Genes Dev, (2000), 14(6), 655-65), Cyclin E (Yeh et al, Biochem Biophys Res Commun., (2001) 281, 884-90), Cln2 cyclin from S. cerevisiae (Berset et al, Mol. Cell Biol., (2002), pp 4463-4476) and p27Kip1 (Montagnoli et al, Genes Dev., (1999), 13(9), 1181-1189, Nakayama et al, EMBO J., (2000), 19(9), 2069-81, Tomoda et al, Nature, (1999), 398(6723), 160-5).

Table 2 lists destruction control elements that may be used according to the invention and indicates the cell cycle phase in which each element is activated.

TABLE 2
Destruction Control Elements

| Element | Timing |
|---|---|
| Cyclin B1 D-box | Metaphase through to G1 phase |
| Cyclin A N-terminus | Prometaphase through to G1 phase |
| KEN box | anaphase/G1 |
| p27Kip1 | G1 |
| Cyclin E | G1/S boundary |
| Cln2 | G1/S boundary |

Alternatively, the destruction control element may be non cell-cycle mediated, such as PEST sequences as described by Rogers et al, Science, (1986), 234, 364-8. Examples of non cell-cycle mediated destruction control elements include sequences derived from casein, ornithine decarboxylase and proteins that reduce protein half-life. Use of such non cell-cycle mediated destruction control sequences in the method of the invention provides means for determining the persistence time of the cell cycle reporter following induction of expression by a cell cycle specific promoter.

Suitably, the live-cell reporter molecule encoded by the nucleic acid sequence may be selected from the group consisting of fluorescent proteins and enzymes. Preferred fluorescent proteins include Green Fluorescent Protein (GFP) from Aequorea victoria and derivatives of GFP such as functional GFP analogues in which the amino acid sequence of wild type GFP has been altered by amino acid deletion, addition, or substitution. Suitable GFP analogues for use in the present invention include EGFP (Cormack, B. P. et al, Gene, (1996), 173, 33-38); EYFP and ECFP (U.S. Pat. No. 6,066,476, Tsien, R. et al); F64L-GFP (U.S. Pat. No. 6,172,188, Thastrup, O. et al); BFP, (U.S. Pat. No. 6,077,707, Tsien, R. et al). Other fluorescent proteins include DsRed, HcRed and other novel fluorescent proteins (BD Clontech and Labas, Y. A. et al, Proc Natl Acad Sci USA (2002), 99, 4256-61) and Renilla GFP (Stratagene). Suitable enzyme reporters are those which are capable of generating a detectable (e.g. a fluorescent or a luminescent) signal in a substrate for that enzyme. Particularly suitable enzyme/substrates include: nitroreductase/Cy-Q (as disclosed in WO 01/57237) and β-lactamase/CCF4.

In a preferred embodiment, the nucleic acid reporter construct may optionally include a cell cycle phase-specific spatial localisation control element comprising a DNA sequence encoding a protein motif that is capable of controlling the sub-cellular localisation of the protein in a cell cycle specific manner. Such a localisation control element may be used advantageously according to the invention where:

i) a specific sub-cellular localisation of the reporter is desirable; and/or

ii) more precise determination of the cell cycle position is required.

It may be required to determine the sub-cellular localisation of the reporter either to ensure its effective operation and/or destruction. More precise determination of the cell cycle position may be possible using a localisation control element since this will permit measurement of both intensity and location of the reporter signal.

Suitable spatial localisation control elements include those that regulate localisation of a cell cycle control protein, for example the cyclin B1 CRS.

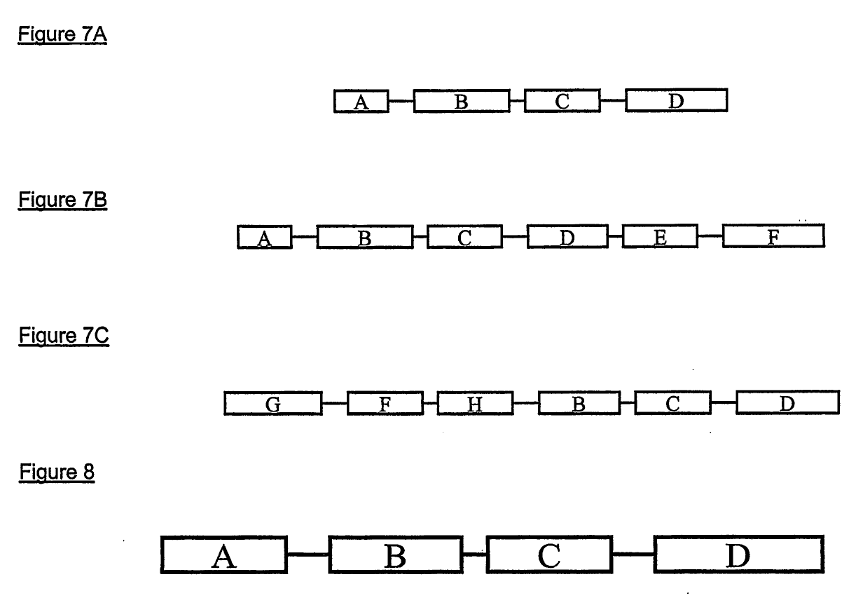

The term “operably linked” as used herein indicates that the elements are arranged so that they function in concert for their intended purposes, e.g. transcription initiates in a promoter and proceeds through the DNA sequence coding for the fluorescent protein of the invention. FIG. 7 illustrates the general construction of a DNA construct according to the invention, in which FIG. 7A shows a construct utilising a cell cycle phase-specific promoter and no internal ribosome entry site (IRES) element, FIG. 7B shows a construct utilising an IRES element to facilitate mammalian selection, and FIG. 7C shows a construct utilising a constituitive or inducible mammalian promoter and a cell cycle phase-specific IRES as the expression control element. In each case A represents a cell cycle phase-specific expression control (promoter), B represents a cell cycle phase specific destruction control element, C represents a cell cycle phase specific localisation control element, D represents a reporter gene, E represents a non-cell cycle specific IRES element, F represents a mammalian selectable marker, G represents a mammalian constitutive promoter and H represents a cell cycle specific IRES element

In a preferred embodiment of the invention, the construct comprises a cyclin B1 promoter, a cyclin B1 destruction box (D-box), a cyclin B1 cytoplasmic retention sequence (CRS) and a green fluorescent protein (GFP).

In one embodiment, the nucleic acid reporter construct comprises an expression vector comprising the following elements:

a) a vector backbone comprising:
i) a bacterial origin of replication; and
ii) a bacterial drug resistance gene;

b) a cell cycle phase specific expression control element;

c) a destruction control element; and

d) a nucleic acid sequence encoding a reporter molecule.

Optionally, the nucleic acid reporter construct additionally contains a cell cycle phase-specific spatial localisation control element and/or a eukaryotic drug resistance gene, preferably a mammalian drug resistance gene.

Expression vectors may also contain other nucleic acid sequences, such as polyadenylation signals, splice donor/splice acceptor signals, intervening sequences, transcriptional enhancer sequences, translational enhancer sequences and the like. Optionally, the drug resistance gene and the reporter gene may be operably linked by an internal ribosome entry site (RES), which is either cell cycle specific (Sachs, et al, Cell, (2000), 101, 243-245) or cell cycle independent (Jang et al, J. Virology, (1988), 62, 2636-2643 and Pelletier and Sonenberg, Nature, (1988), 334, 320-325), rather than the two genes being driven from separate promoters. When using a non cell-cycle specific IRES element the pIRES-neo and pIRES-puro vectors commercially available from Clontech may be used.

In a particular embodiment, the nucleic acid reporter construct is assembled from a DNA sequence encoding the cyclin B1 promoter operably linked to DNA sequences encoding 171 amino acids of the amino terminus of cyclin B1 and a DNA sequence encoding a green fluorescent protein (GFP) (FIG. 8). The construct illustrated in FIG. 8 contains a cyclin B1 promoter (A), cyclin B1 destruction box (D-box) (B), cyclin B1 CRS (C) and a GFP reporter (D). Motifs controlling the localisation and destruction of cyclin B1 have all been mapped to ˜150 amino acids in the amino terminus of the molecule. Consequently, an artificial cell cycle marker can be constructed using only sequences from the amino terminus of cyclin B1, which will not interfere with cell cycle progression since it lacks a specific sequence, termed the cyclin box, (Nugent et al, J. Cell. Sci., (1991), 99, 669-674) which is required to bind to and activate a partner kinase. Key regulatory motifs required from the amino terminus sequence of cyclin B1 are:

i) a nine amino acid motif termed the destruction box (D-box). This is necessary to target cyclin B1 to the ubiquitination machinery and, in conjunction with at least one C-terminal lysine residue, this is also required for its cell-cycle specific degradation;

ii) an approximately ten amino acid nuclear export signal (NES). This motif is recognised, either directly or indirectly, by exportin 1 and is sufficient to maintain the bulk of cyclin B1 in the cytoplasm throughout interphase;

iii) approximately four mitosis-specific phosphorylation sites that are located in and adjacent to the NES and confer rapid nuclear import and a reduced nuclear export at mitosis.

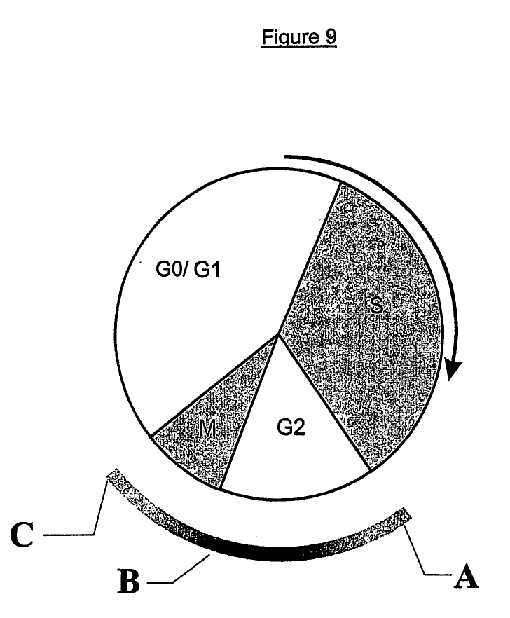

When expressed in a eukaryotic cell, the construct will exhibit cell cycle specific expression and destruction of the GFP reporter which parallels the expression and degradation of endogenous cyclin B1. Hence, measurement of GFP fluorescence intensity permits identification of cells in the G2/M phase of the cell cycle (FIG. 9). Furthermore, since the fluorescent product of the construct will mimic the spatial localisation of endogenous cyclin B1, analysis of the sub-cellular distribution of fluorescence permits further precision in assigning cell cycle position. At prophase, cyclin B1 rapidly translocates into the nucleus, consequently the precise localisation of GFP fluorescence in the cell can be used to discriminate cells transitioning from interphase to mitosis. Once a cell reaches metaphase, and the spindle assembly checkpoint is satisfied, cyclin B1 is very rapidly degraded, and consequently the disappearance of GFP fluorescence can be used to identify cells at mid-M phase.

Expression of the construct in a population of unsynchronised cells will result in each cell exhibiting cyclical expression and destruction of the fluorescent product from the construct, resulting in a continuous blinking pattern of fluorescence from all cells in the population. Analysis of the fluorescence intensity of each cell with time consequently yields dynamic information on the cell cycle status of each cell.

Further embodiments of the nucleic acid reporter construct according to the first aspect may be constructed by selecting suitable alternative cell cycle control elements, for example from those shown in Tables 1 and 2, to design cell cycle phase reporters which report a desired section of the cell cycle.

The construction and use of expression vectors and plasmids are well known to those of skill in the art. Virtually any mammalian cell expression vector may be used in connection with the cell cycle markers disclosed herein. Examples of suitable vector backbones which include bacterial and mammalian drug resistance genes and a bacterial origin of replication include, but are not limited to: pCI-neo (Promega), pcDNA (Invitrogen) and pTriEx1 (Novagen). Suitable bacterial drug resistance genes include genes encoding for proteins that confer resistance to antibiotics including, but not restricted to: ampicillin, kanamycin, tetracyclin and chloramphenicol. Eurkaryotic drug selection markers include agents such as: neomycin, hygromycin, puromycin, zeocin, mycophenolic acid, histidinol, gentamycin and methotrexate.

The DNA construct may be prepared by the standard recombinant molecular biology techniques of restriction digestion, ligation, transformation and plasmid purification by methods familiar to those skilled in the art and are as described in Sambrook, J. et al (1989), Molecular Cloning—A Laboratory Manual, Cold Spring Harbor Laboratory Press. Alternatively, the construct can be prepared synthetically by established methods, e.g. the phosphoramidite method described by Beaucage and Caruthers, (Tetrahedron Letters, (1981), 22, 1859-1869) or the method described by Matthes et al (EMBO J., (1984), 3, 801-805). According to the phosphoramidite method, oligonucleotides are synthesised, e.g. in an automatic DNA synthesizer, purified, annealed, ligated and cloned into suitable vectors. The DNA construct may also be prepared by polymerase chain reaction (PCR) using specific primers, for instance, as described in U.S. Pat. No. 4,683,202 or by Saiki et al (Science, (1988), 239, 487-491). A review of PCR methods may be found in PCR protocols, (1990), Academic Press, San Diego, Calif., U.S.A.

During the preparation of the DNA construct, the gene sequence encoding the reporter must be joined in frame with the cell cycle phase specific destruction control element and optionally the spatial localisation control element. The resultant DNA construct should then be placed under the control of one or more suitable cell cycle phase specific expression control elements.

The host cell into which the construct or the expression vector containing such a construct is introduced, may be any cell which is capable of expressing the construct and may be selected from eukaryotic cells for example, from the group consisting of a mammalian cell, a fungal cell, a nematode cell, a fish cell, an amphibian cell, a plant cell and an insect cell.

The prepared DNA reporter construct may be transfected into a host cell using techniques well known to the skilled person. One approach is to temporarily permeabilise the cells using either chemical or physical procedures. These techniques may include: electroporation (Tur-Kaspa et al, Mol. Cell Biol. (1986), 6, 716-718; Potter et al, Proc. Nat. Acad. Sci. USA, (1984), 81, 7161-7165), a calcium phosphate based method (eg. Graham and Van der Eb, Virology, (1973), 52, 456-467 and Rippe et al, Mol. Cell Biol., (1990), 10, 689-695) or direct microinjection.

Alternatively, cationic lipid based methods (eg. the use of Superfect (Qiagen) or Fugene6 (Roche) may be used to introduce DNA into cells (Stewart et al, Human Gene Therapy, (1992), 3, 267; Torchilin et al, FASEB J, (1992), 6, 2716; Zhu et al, Science, (1993), 261, 209-211; Ledley et al, J. Pediatrics, (1987), 110, 1; Nicolau et al, Proc. Nat. Acad. Sci., USA, (1983), 80, 1068; Nicolau and Sene, Biochem. Biophys. Acta, (1982), 721, 185-190). Jiao et al, Biotechnology, (1993), 11, 497-502) describe the use of bombardment mediated gene transfer protocols for transferring and expressing genes in brain tissues which may also be used to transfer the DNA into host cells.

A further alternative method for transfecting the DNA construct into cells, utilises the natural ability of viruses to enter cells. Such methods include vectors and transfection protocols based on, for example, Herpes simplex virus (U.S. Pat. No. 5,288,641), cytomegalovirus (Miller, Curr. Top. Microbiol. Immunol., (1992), 158, 1), vaccinia virus (Baichwal and Sugden, 1986, in Gene Transfer, ed. R. Kucherlapati, New York, Plenum Press, p 117-148), and adenovirus and adeno-associated virus (Muzyczka, Curr. Top. Microbiol. Immunol., (1992), 158, 97-129).

Examples of suitable recombinant host cells include HeLa cells, Vero cells, Chinese Hamster ovary (CHO), U2OS, COS, BHK, HepG2, NIH 3T3 MDCK, RIN, HEK293 and other mammalian cell lines that are grown in vitro. Such cell lines are available from the American Tissue Culture Collection (ATCC), Bethesda, Md., U.S.A. Cells from primary cell lines that have been established after removing cells from a mammal followed by culturing the cells for a limited period of time are also intended to be included in the present invention.

Cell lines which exhibit stable expression of a cell cycle position reporter may also be used in establishing xenografts of engineered cells in host animals using standard methods. (Krasagakis, K. J et al, Cell Physiol., (2001), 187(3), 386-91; Paris, S. et al, Clin. Exp. Metastasis, (1999), 17(10), 817-22). Xenografts of tumour cell lines engineered to express cell cycle position reporters will enable establishment of model systems to study tumour cell division, stasis and metastasis and to screen new anticancer drugs.

Use of engineered cell lines or transgenic tissues expressing a cell cycle position reporter as allografts in a host animal will permit study of mechanisms affecting tolerance or rejection of tissue transplants (Pye D and Watt, D. J., J. Anat., (2001), 198 (Pt 2), 163-73; Brod, S. A. et al, Transplantation (2000), 69(10), 2162-6).

To perform the method for determining the cell cycle position of a cell according to the second aspect, cells transfected with the DNA reporter construct may be cultured under conditions and for a period of time sufficient to allow expression of the reporter molecule at a specific stage of the cell cycle. Typically, expression of the reporter molecule will occur between 16 and 72 hours post transfection, but may vary depending on the culture conditions. If the reporter molecule is based on a green fluorescent protein sequence the reporter may take a defined time to fold into a conformation that is fluorescent. This time is dependent upon the primary sequence of the green fluorescent protein derivative being used. The fluorescent reporter protein may also change colour with time (see for example, Terskikh, Science, (2000), 290, 1585-8) in which case imaging is required at specified time intervals following transfection.

In the embodiment of the invention wherein the nucleic acid reporter construct comprises a drug resistance gene, following transfection and expression of the drug resistance gene (usually 1-2 days), cells expressing the modified reporter gene may be selected by growing the cells in the presence of an antibiotic for which transfected cells are resistant due, to the presence of a selectable marker gene. The purpose of adding the antibiotic is to select for cells that express the reporter gene and that have, in some cases, integrated the reporter gene, with its associated promoter, IRES elements, enhancer and termination sequences into the genome of the cell line. Following selection, a clonal cell line expressing the construct can be isolated using standard techniques. The clonal cell line may then be grown under standard conditions and will express reporter molecule and produce a detectable signal at a specific point in the cell cycle.

### EXAMPLES OF PRODUCTION OF STABLE CELL LINES

### Example 1

### Preparation of DNA Construct

i) The N-terminal third of the cyclin B1 mRNA (amino acids 1-171), encoding the cyclin B1 destruction box and the NES was amplified with HindIII and BamHI ends using standard PCR techniques and the following primers:

GGGAAGCTTAGGATGGCGCTCCGAGTCACCAGGAAC
GCCGGATCCCACATATTCACTACAAAGGTT.

ii) The gene for wtGFP was amplified with primers designed to introduce restriction sites that would facilitate construction of fusion proteins. The PCR product was cloned into pTARGET (Promega) according to manufacturer's instructions and mutations (F64L/S175G/E222G) were introduced using the QuikChange site-directed mutagenesis kit (Stratagene). Constructs were verified by automated DNA sequencing. DNA encoding the mutant GFP was then cloned downstream of the cyclin B1 N-terminal region using BamHI and SalI restriction sites.

iii) The cell cycle dependent region of the cyclin B1 promoter (−150→+182) was amplified with SacII and HindIII sites and cloned upstream of the Cyclin B1 N-terminal region and the GFP fusion protein.

iv) The promoter and recombinant protein encoding DNA was excised and cloned in place of the CMV promoter in a BglII/NheI cut pCI-Neo derived vector.

### Example 2

### Effect of Cell Cycle Blocking Agents on GFP Fluorescence from Cell Cycle Phase Marker Using Transiently Transfected Cells

U2OS cells (ATCC HTB-96) were cultured in wells of a 96 well microtitre plate. Cells were transfected with a cell cycle reporter construct prepared according to Example 1, comprising a cyclin B1 promoter operably linked to sequences encoding the cyclin B1 D-box, the cyclin B1 CRS, and GFP in a pCORON4004 vector (Amersham Biosciences) using Fugene 6 (Roche) as the transfection agent.

Following 24 hours of culture, cells were exposed to the specific cell cycle blockers mimosine (blocks at G1/S phase boundary) or demecolcine (blocks in M phase). Control cells were exposed to culture media alone.

Cells were incubated for a further 24 hours and then analysed for nuclear GFP expression using a confocal scanning imager with automated image analysis (IN Cell Analysis System, Amersham Biosciences).

Cells exposed to demecolcine showed increased fluorescence compared to control cells while cells exposed to mimosine showed decreased fluorescence compared to control cells. Cells blocked in G1/S phase (mimosine treated), prior to the time of activation of the cyclin B1 promoter, show reduced fluorescence, while cells blocked in M phase (demecolcine treated), prior to the time of action of the cyclin B1 D-box, show increased fluorescence.

### Example 3

### Microinjection of the Construct

HeLa cells were micro-injected with the construct prepared according to Example 1 and examined by time lapse microscopy. Differential interference contrast (DIC) images were made along with the corresponding fluorescence images. A cell in metaphase showed bright fluorescence in the nucleus. The same cell was imaged similarly at later times in anaphase and late anaphase. The DIC images showed the division of the cell into two daughter cells, the corresponding fluorescence images showed the loss of fluorescence accompanying destruction of the fluorescent construct as the cell cycle progresses.

### Example 4

### Stable Cell Line Production

U2-OS cells (ATCC HTB-96) were transfected with the construct described in Example 1 and grown for several months in culture media containing 1 mg/ml geneticin to select for cells stably expressing the construct. A number of clones were picked by standard methods (e.g. described in Freshney, Chapter 11 in Culture of Animal Cells, (1994) Wiley-Liss Inc) and a clone containing fluorescent cells was isolated. This cell line was maintained at 37° C. in culture media containing 25 mM HEPES.

### Example 5

### Preparation of a Brighter Stable Cell Line

The green fluorescent protein reporter sequence in the vector described in example 1 was replaced with enhanced GFP (EGFP; Cormack, B. P. et al, Gene, (1996), 173, 33-38; BD Clontech) by standard methods. The EGFP gene is a brighter form of GFP containing the mutations F64L and S65T. In addition, EGFP contains codons that have been altered to optimise expression in mammalian cells. This new construct was transfected into U2-OS cells and a number of colonies were isolated by selection with geneticin followed by sorting of single cells using a fluorescence activated cell sorter. These clones showed brighter fluorescence than those generated in example 4 and as expected fluorescence intensity and location appeared to vary according to the cell cycle phase of the cell.

Assays and Image Acquisition

According to embodiments of the invention, screening assays are conducted using libraries of chemical compounds. One or more multiwell plates are prepared using a cell line as described above. Whilst in the following embodiments a cell line including a cell cycle reporter construct as described in Example 1 above is used, it should be appreciated that any other of the described embodiments of cell line can be used in alternative embodiments. A controlled amount of cells, referred to herein as a population is placed in a carrier solution in each of the wells of the plate and allowed to establish for a predetermined period, for example 24 hours. Next, a different one of the library of chemical compounds is added in a controlled concentration and amount to each of the wells and allowed to stand for a predetermined period, for example 24 hours. In some embodiments of the invention, a nuclear stain is added before imaging is conducted. In other embodiments of the invention, no nuclear stain is added before imaging is conducted. Next, imaging is conducted for each well of the plate in turn, using a confocal microscope as described above. A small area in the centre of each well, at the bottom of the well, is imaged to acquire image data in one or more channels of the selected area. The fluorescence detected in the confocal microscope is converted into one or more digital images in which the digital values are proportional to the intensity of the fluorescent radiation incident on each pixel of the detection device.

Image Processing and Analysis

In general the processing and analysis of the image data in accordance with the invention comprises a number of discrete steps. The image data are analyzed to identify areas of image data corresponding to individual cells. Such object areas may be sub-cellular components of individual cells, such as the cell nuclei. A binary mask is generated from one of the digital images in which all values meeting one or more criteria are replaced by one, all values failing to meet the criteria are replaced by zero. Generally, the one or more criteria include a threshold value determined from an image taken in a set-up procedure for the assay. The mask is searched for groups of contiguous value-one pixels to identify the object areas corresponding to individual cells. Next, measurements are made on the individual cells using the identified object areas. Classification rules are applied to the measurements to classify individual cells into a selected one of a plurality of sub-populations of cells in different cell cycle phases. For each identified object area, values of the corresponding pixels in the same image or in another image are analysed. Measurements relating to the identified object areas are calculated from the positions of pixels in the image and the intensities of pixels in the image. The classification rules are applied to the calculated measurements to classify each identified cell in an analysed part of the image in turn, and the classification data are written to an output data file for the assay. In this way, it is possible to determine, in a high throughput automated process, cell cycle phase data indicative of the relative sizes of the plurality of sub-populations in the population of cells. The process is repeated in quick succession for each of the one or more images acquired in each of the wells of the plate in turn.

### First Embodiment

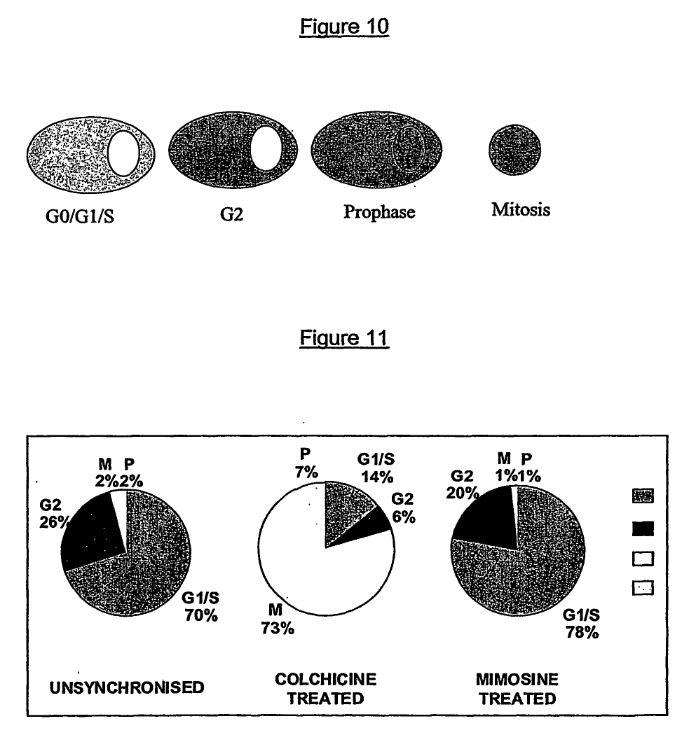

The cell cycle phase marker used has a fluorescence signal that varies according to the phase of the cell cycle of the cell in a manner which is illustrated in FIG. 10. Four different patterns can be distinguished in this embodiment of the invention:
1. G0/G1/S phase cells have relatively low expression of the cell cycle phase marker, both in the nucleus and the cytoplasm;
2. G2 cells have relatively low nuclear, and relatively high cytoplasmic, expression of the cell cycle phase marker
3. M cells have relatively high nuclear expression, with substantially no cytoplasmic expression of the cell cycle phase marker,
4. P cells have relatively high nuclear, and relatively high cytoplasmic, expression of the cell cycle phase marker.

Object Area Identification

A nuclear marker, producing fluorescence at a wavelength different to that of the cell cycle phase marker, is used in this embodiment to identify nuclear areas for each cell under analysis in the image data. The nuclear marker may be one of the toxic intercalating nuclear dyes (such as DRAQ5™ or a Hoechst™ dye, for example Hoechst 33342). Alternatively, in assays in which the same cell population is imaged and analysed to determine its relative cell cycle sub-populations a number of times during a time course study, a non-toxic nuclear marked may be used. Such a non-toxic marker may be in the form of an NLS-fluorescent protein fusion. For example, the Clontech™ pHcRed1-Nuc vector, when transfected into a cell line in accordance with the present invention, produces a red fluorescence signal in the nucleus. During image acquisition, an image of the cell nuclei is acquired in a first channel corresponding to the nuclear marker, a cell cycle phase analysis image is acquired in a second channel corresponding to the cell phase marker, and the two images are coregistered such that the pixels of each image are aligned.

The cell nuclei image is analysed first to identify nuclear areas in the image data. The operator sets a nuclear signal threshold in the cell nuclei image by visually inspecting the image and the corresponding thresholded image to ensure that the threshold accurately differentiates the edges of the nuclear areas. A segmentation algorithm, for example a watershed segmentation algorithm (S. Beucher, F. Meyer, “Morphological Segmentation”, Journal of Visual Communication and Image Representation, 1:21-46, 1990 and Vincent, Soille, IEEE Transactions on Pattern Analysis and Machine Intelligence, 13:583-598, 1991) is applied to the thresholded image to uniquely identify the area of the nucleus of each individual cell being analysed.

From each nuclear object area identified, two binary masks, defining object areas in which the cell measurements are to be taken, are generated—an eroded nuclear mask (to sample the cell cycle phase marker intensity signal in the central part of nucleus) and a thin cytoplasmic ring (to sample the cell cycle phase marker intensity signal in the cytoplasm near the nucleus). The nuclear object area is eroded from the edge of the nuclear object by a predetermined number of pixels, for example three pixels, to generate the eroded nuclear mask. To generate the thin cytoplasmic ring, representing the cytoplasmic area adjacent to the nucleus, the nuclear object is dilated from its edge by a predetermined number of pixels, for example two pixels.

Measurements on Individual Cells

The two masks, generated for each individual cell as described above are then applied to the cell cycle phase analysis image.

The fluorescence signal intensities in each pixel in the eroded nuclear mask area are averaged to produce an average nuclear signal intensity (Iₙ) which represents the average intensity over the nuclear area.

The fluorescence signal intensities in each pixel in the thin cytoplasmic ring are averaged to produce an average cytoplasmic signal intensity (I_{c}) representing the average intensity within cytoplasmic sampling ring. Note that, in the case of a mitotic cell, the “cytoplasmic” luminescence signal intensity, whilst taken in an area generally corresponding to a cytoplasmic component of a selected cell, is mainly outside the bounds of the cell (and therefore tends to be relatively low.)

The ratio of the two measured average intensities is then taken to generate the nuclear/cytoplasmic ratio

$$( \frac{{I}_{n}}{{I}_{c}} ) ,$$

representing the ratio of nuclear and cytoplasmic average intensities.

Classification of Cells

Three further thresholds are set by the operator, by inspecting the cell cycle phase analysis image and the measurements output for selected objects in the image, to enable the automatic classification process. The operator manually selects cells corresponding to each of the different cell cycle phases and sets the thresholds to accurately differentiate between them.

The nuclear threshold (Tₙ) is set to separate G0/G1/S and G2 phase cells from M and P phase cells. The value is selected to be approximately midway between that of typical M and P phase cells, which have relatively high average nuclear signal intensity, and that of typical G0/G1/S and G2 phase cells, which have relatively low average nuclear signal intensity.

The cytoplasmic threshold (T_{c}) is set to separate G0/G1/S phase cells from G2 and P phase cells. The value is selected to be approximately midway between that of typical G2 and P cells, which have relatively high average cytoplasmic signal intensity and that of typical G0/G1/S cells, which have relatively low average cytoplasmic intensity signal.

The nuclear/cytoplasmic intensity threshold (T_{n/c}) is set to separate M phase cells from P phase cells. The value is selected to be approximately midway between the nuclear/cytoplasmic ratio for typical M phase cells, which is relatively low, and that of typical P cells, which is relatively high.

These thresholds are set by the operator selecting individual cell objects (for example by right-clicking a mouse when pointing at the relevant nucleus on screen). The comparison is repeated in a number of different wells of a plate, to ensure consistency of the settings across the whole assay.

A threshold selection can alternatively be made based on automatically-generated histograms or scatter-plots of the corresponding parameters in each well. The thresholds themselves may also be determined automatically by the image processing application, based on measuring signals in a control well and adjusting the threshold to ensure that there is an expected proportion of cells seen in each cell cycle phase. Alternatively, automated threshold selection can be performed by pattern recognition in the scatter plots or other data representation. Further alternatively, the image processing application may be adapted to learn to select thresholds based on the manual selections performed by the user in past assays.

Once the threshold values are selected, the automated classification process can be conducted on all image data acquired in the assay. The classification rules used to identify cell phases with the reference to the thresholds are in this embodiment as follows:

$$If ( {I}_{n} \leq {T}_{n} AND {I}_{c} \leq {T}_{c} ) THEN object = G 0 / G 1 / S . \\ If ( {I}_{n} \leq {T}_{n} AND {I}_{c} > {T}_{c} ) THEN object = G 2.$$

$$If ( {I}_{n} > {T}_{n} AND \frac{{I}_{n}}{{I}_{c}} \leq {T}_{n / c} ) THEN object = P$$

$$If ( {I}_{n} > {T}_{n} AND \frac{{I}_{n}}{{I}_{c}} > {T}_{n / c} ) THEN object = M$$

Data Output.

The results of the classification for each well, or at least some wells, of each plate in the assay is output as a data file including, against each well identifier, cell cycle phase population data output in the form of a percentage of the population (the sub-population) in each of the G0/G1/S, G2, M and P phases of the cell cycle. In addition, or alternatively, cell cycle phase data may be output on a per-cell basis, once the cell cycle phase of the cell has been identified.

### Example of Results Obtained Using this Embodiment

FIG. 11 shows the results obtained in one assay performed in accordance with the invention. Stably transfected U2OS cells were treated with either colchicine (an M phase blocking drug) or mimosine (an agent known to cause a block in G0/G1/S cell phase). Cells, including unsynchronised cells as a control, were analysed using the method of the present invention. Similar results were obtained when the cells were analysed by Fluorescence Activated Cell Sorter (FACS) analysis, indicating that the method of the invention reliably distinguished the cell cycle phases.

### Second Embodiment

This embodiment is based upon the first embodiment, using a procedure as described above and with an adapted cell classification process. An additional measurement parameter, based on those described above, is calculated for each cell. Using this additional parameter, the cell classification rules can be based upon a reduced number of thresholds. This has the advantage of straightforward visualisation and therefore is more intuitive and accessible, and only two classification thresholds need to be defined.

In this embodiment the additional parameter is defined as follows:
ρ=|1−R|,
where R is the nuclear/cytoplasmic ratio. This parameter is an absolute value (magnitude), and its value is used to differentiate between differences of the cell phases in combination with the average nuclear intensity signal Iₙ.

The operator sets classification thresholds in a manner similar to that described above, however in this embodiment there are only two to be set. The nuclear threshold (Tₙ) is set to separate G0/G1/S and G2 phase cells from M and P phase cells. The value is selected to be approximately midway between that of typical M and P phase cells, which have relatively high average nuclear signal intensity, and that of typical G0/G1/S and G2 phase cells, which have relatively low average nuclear signal intensity.

A second threshold (T_{ρ}) is set to separate G0/G1/S and P phase cells from G2 and M phase cells. The value is selected to be approximately midway between that of typical G0/G1/S and P phase cells, which have a relatively high value of the parameter p and that of typical G2 and M phase cells, which have a relatively low value of the parameter ρ.

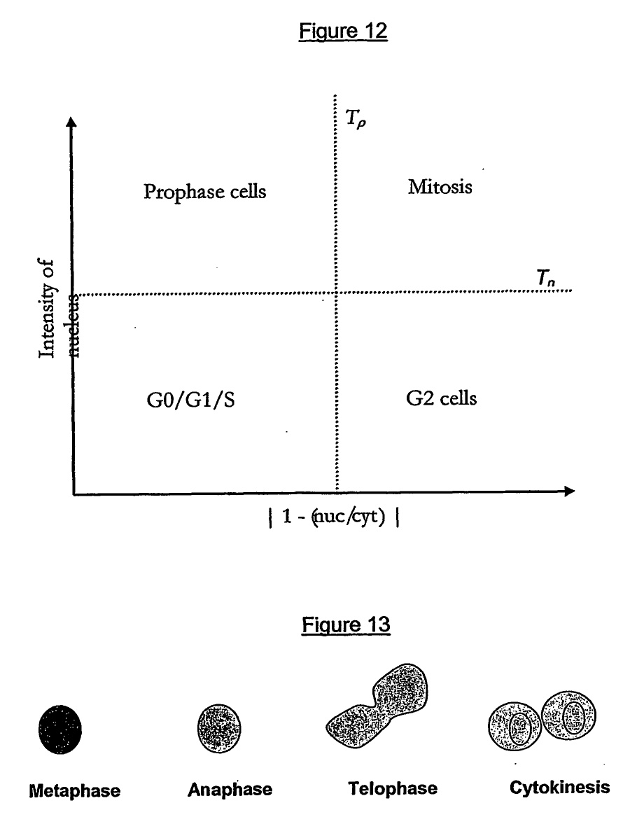

The classification rules used in this embodiment are as follows:
If (Iₙ≦TₙAND|1−R|≦T_{ρ}) THEN object=G0/G1/S.
If (Iₙ≦Tₙ AND|1−R|>T_{ρ}) THEN object=G2.
If (Iₙ>TₙAND|1−R|≦T_{ρ}) THEN object=P
If (Iₙ>TₙAND|1−R|>T_{ρ}) THEN object=M
A schematic illustration of these classification rules is shown in FIG. 12.

### Third Embodiment

The method of this embodiment provides a process for automatically classifying cells in different phases of the cell cycle based only on the cell cycle phase marker signal, and obviates the need for the use of a nuclear marker. An image is acquired in only the channel corresponding to the fluorescence of the cell phase marker fluorescence. A cell segmentation algorithm is applied once the image is thresholded to produce a binary cell mask for each cell. The whole cell mask is generated using a signal threshold set by the operator by selecting typical G1S cells in the image and setting the threshold higher than the average nuclear signal intensity in these cells.

Cell cycle phase analysis is then based on combination of intensity, signal texture, size and shape parameters, specific for each of the phases of cell cycle. Cells from different cell cycle phases are identified via the setting of corresponding classification thresholds, as described in further detail below.

Exemplary measurement parameters calculated by the image processing and analysis software application in this embodiment include:

I—Average intensity of signal within the cell;

F—Fraction of pixels that deviate more than 10% from average signal within the cell;

H—Heterogeneity, the area of the holes (groups of pixels with intensity below the threshold) inside the object;

A—Aspect, the ratio between major and minor axes of cell outline (nearest-fit ellipse);

R—Radius, the maximum width of the cell;

L—Length, average width of the cell;

C—Clumpiness (signal texture);

M—Margination.

Specific combination of the parameters, and their relationships to thresholds which are set based on cell type and on a per-assay basis, are used as classification rules for each of the cell phases to be identified in the automated cell classification process. The phases to be identified preferably include each of G0/G1/S, G2, M and P phase cells. Furthermore, in this embodiment the mitotic cells can be distinguished into MP (metaphase) cells. A (anaphase) cells, T (telophase) cells and C (cytokinesis) cells. Schematic illustrations of the signal intensities and distributions of the fluorescent reporter in these cell cycle phases are shown in FIG. 13. Early G1 phase cells can also be distinguished in this embodiment

An example of a set of classification rules to be used in this embodiment is as follows:

| | |
|---|---|
| earlyG1 = | I < 100, A > 1.5, H <= 20, 0 < F < 0.1 |
| G1 = | I < 100, H > 20, F < 0.1 |
| G2 = | I < 40, I < 100, F > 0.1, H >= 0, R > 40 |
| P = | I > 100, H < 10, L > 45 |
| MP = | I > 100, A < 1.5, R < 40, L <= 45, F > 0.5 |
| A = | I < 100, A < 1.5, R < 40, L <= 55, F = 0, T > 0 |
| T = | I < 100, A > 1.5, L > 55, H = 0, F = 0 |
| C = | I <= 100, A < 1.5, R < 70, H <= 20, F < 0.2, T = 0 |

Here, bold marked thresholds are reset by the operator for each assay, and italic marked thresholds are size/cell shape-dependent and are reset only if a different cell type is used.

Note that, although the margination parameter M is not used in the above example set of classification rules, it can be used in an alternative set.

The above embodiments are to be understood as illustrative examples of the invention. Further embodiments of the invention are envisaged. Note that the term “luminescence” as used herein is intended to include the phenomena of fluorescence and other types of luminescence such as chemiluminescence and phosphorescence. The cell cycle position of the cells may be determined in various alternative embodiments of the invention by monitoring the expression of the reporter molecule and detecting luminescence signals emitted by the reporter using an appropriate detection device. If the reporter molecule produces a fluorescent signal, then, either a conventional fluorescence microscope, or a confocal based fluorescence microscope may be used. If the reporter molecule produces luminous light, then a suitable device such as a luminometer may be used. Using these techniques, the proportion of cells expressing the reporter molecule may be determined. If the DNA construct contains translocation control elements and the cells are examined using a microscope, the location of the reporter may also be determined. In the method according to the present invention, the fluorescence of cells transformed or transfected with the DNA construct may suitably be measured by optical means in for example; a spectrophotometer, a fluorimeter, a fluorescence microscope, a cooled charge-coupled device (CCD) imager (such as a scanning imager or an area imager), a fluorescence activated cell sorter, a confocal microscope or a scanning confocal device, where the spectral properties of the cells in culture may be determined as scans of light excitation and emission.

Whilst in the above embodiments, a processing method is used which uses pre-stored classification rules to classify a selected cell into a selected one of a plurality of sub-populations of cells in different cell cycle phases, other classification methods may be implemented, such as the use of a neural network.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of determining cell cycle phase data for cells which include at least one luminescent reporter capable of emitting radiation, the at least one luminescent reporter including a first luminescent reporter which is capable of being indicative of at least one cell cycle phase, said method comprising:
storing classification information for classifying individual cells into different cell cycle phases using an automated classification process;
receiving image data created by detecting radiation emitted by said at least one luminescent reporter;
analyzing said image data to identify object areas in the image data which correspond to individual cells;
analyzing said image data, on the basis of said identified object areas, to determine, for a selected cell, one or more measurements including a measurement of a parameter relating to at least a cytoplasmic component of the cell; and
applying said classification information to said measurements to classify the selected cell into a selected one of a plurality of sub-populations of cells, each sub-population having cells in a different cell cycle phase.

2. The method of claim 1, further comprising analyzing said image data and applying said classification information to each of a plurality of selected cells, and generating, for said plurality of selected cells, cell cycle phase population data indicative of the relative sizes of said plurality of sub-populations in the selected cells.

3. The method of claim 1, further comprising performing the method with image data from a plurality of wells containing cells, the said plurality of wells containing different test compounds.

4. The method of claim 1, wherein the at least one luminescent reporter further includes a second luminescent reporter indicative of the location of a sub-cellular component in a cell,
wherein said step of receiving image data comprises:
a) receiving first image data created by detecting radiation emitted by said first luminescent reporter; and
b) receiving second image data created by detecting radiation emitted by said second luminescent reporter,
wherein said step of analyzing said image data to identify object areas comprises analyzing said second image data, and
wherein said step of analyzing said image data to determine one or more measurements comprises analyzing said first image data.

5. The method of claim 1, wherein said object areas include, for a selected cell, a first type of object area and a second type of object area, and wherein said one or more measurements include a first measurement determined using said first type of object area and a second measurement determined using said second type of object area.

6. The method of claim 5, wherein said first type of object area is identified using a process arranged to select a predominantly nuclear area of a cell.

7. The method of claim 5, wherein said second type of object area is identified using a process arranged to select a predominantly cytoplasmic area of a cell.

8. The method of claim 5, wherein said classification information comprises a first classification rule which classifies a selected cell into a selected first one of the plurality of sub-populations of cells, the first classification rule taking into account both said first measurement and said second measurement.

9. The method of claim 5, wherein said classification information comprises a second classification rule which classifies a selected cell into a selected second one of the plurality of sub-populations of cells, the second classification rule taking into account both said first measurement and said second measurement

10. The method of claim 1, wherein said one or more measurements include a measurement of a cytoplasmic luminescence signal intensity, taken in an area generally corresponding to a cytoplasmic component of a selected cell.

11. The method of claim 1, wherein said one or more measurements include a measurement of a nuclear luminescence signal intensity, taken in an area generally corresponding to a nuclear component of a selected cell.

12. The method of claim 10, wherein said classification information includes a rule operative to classify a selected cell, having a relatively low nuclear luminescence signal intensity and a relatively low cytoplasmic luminescence signal intensity, into a first cell cycle phase sub-population.

13. The method of claim 10, wherein said classification information includes a rule operative to classify a selected cell, having a relatively low nuclear luminescence signal intensity and a relatively high cytoplasmic luminescence signal intensity, into a second cell cycle phase sub-population.

14. The method of claim 10, wherein said classification information includes a rule operative to classify a selected cell, having a relatively high nuclear luminescence signal intensity and a relatively low nuclear to cytoplasmic luminescence signal intensity ratio, into a third cell cycle phase sub-population.

15. The method of claim 10, wherein said classification information includes a rule operative to classify a selected cell, having a relatively high nuclear luminescence signal intensity and a relatively high nuclear to cytoplasmic luminescence signal intensity ratio, into a fourth cell cycle phase sub-population.

16. The method of claim 10, wherein said classification information includes a first parameter derived from said measurements which, in combination with a second parameter derived from said measurements, uniquely identifies each one of four different cell cycle phase sub-populations.

17. The method of claim 1, wherein said step of receiving image data comprises receiving first image data created by detecting radiation emitted by said first luminescent reporter, and
wherein said step of analyzing said image data to determine one or more measurements comprises analyzing said first image data.

18. The method of claim 17, wherein said step of analyzing said image data to identify object areas comprises analyzing said first image data.

19. The method of claim 17, wherein said object areas are identified using a process arranged to select an area including both nuclear and cytoplasmic areas of a cell.

20. The method of claim 17, wherein said one or more measurements include, for a selected cell, a first measurement determined using an identified object area and a second measurement determined using an identified object area.

21. The method of claim 20, wherein said first and second measurements are determined using the same identified object area.

22. The method of claim 20, wherein said classification information comprises a classification rule which classifies a selected cell into a selected first one of the plurality of sub-populations of cells, the classification rule taking into account both said first measurement and said second measurement.

23. The method of claim 17, wherein said one or more measurements include a measurement of a luminescence signal intensity, taken in an identified object area.

24. The method of claim 17, wherein said one or more measurements include one or more measurements selected from the group consisting of:
a parameter relating to an average signal intensity within an identified object area;
a parameter relating to a fraction of pixels that deviate more than a given amount from an average signal intensity within an identified object area;
a parameter relating to the number of pixels with a signal intensity below a given threshold within an identified object area;
a parameter relating to a ratio between major and minor axes of an elliptical outline corresponding to an identified object area;
a parameter relating to a maximum width of an identified object area;
a parameter relating to an average width of an identified object area;
a parameter relating to signal texture within an identified object area; and
a parameter relating to margination in an identified object area.

25. The method of claim 1, wherein said cells comprise a nucleic acid reporter construct, including a nucleic acid sequence encoding a detectable live-cell reporter molecule operably linked to and under the control of:
i) at least one cell cycle phase-specific expression control element, and
ii) a destruction control element.

26-28. (canceled)
